(19) United States
(12) Patent Application Publication
(10) Pub. No.: US 2002/0087389 A1
(43) Pub. Date: Jul. 4, 2002

(54) Value your home

(76) Inventors: Michael Sklarz, Honolulu, HI (US); John R. Willey JR., Honolulu, HI (US)

Correspondence Address: GEORGE E. DARBY, P.O. BOX 893010, MILILANI, HI, 96789-3010, US

(21) Appl. No.: 09/942,415

(22) Filed: Aug. 28, 2001

Related U.S. Application Data
(60) Provisional application No. 60/228,899, filed on Aug. 28, 2000.

(51) Int. Cl. G06F 17/60

(52) U.S. Cl. 705/10

(57) ABSTRACT

The Value Your Home invention collects real estate, and real estate related, data from various sources, adjusts and filters the data, processes that data using trend analysis, comparable market analysis, buy/sell signal analysis, and appraisal engines, responds to user inputs, and provides information outputs and trend, comparable market analysis, buy/sell signal, and appraisal decision tools to users.

### RELATED APPLICATIONS

This application claims the benefit of the provisional patent application, Ser. No. 60/228,899, filed on Aug. 28, 2000, in the U.S. Patent and Trademark Office for an invention entitled “Value Your Home”.

### BACKGROUND OF THE INVENTION

1. Field of the Invention

This invention relates generally to the delivery of real estate sales price information, identification and comparisons of comparable real properties, and sales price predictions. In particular, the invention relates to Web-based services for providing historical real estate sales information, trend analysis, comparable market analysis, buy/sell signals, and individually tailored appraisals. The term “appraisal” means herein an estimated appraisal (predicted sales price), as opposed to a formal appraisal prepared by a certified or licensed appraiser.

2. Description of Related Art

Real estate market information is important to home buyers and sellers, real estate brokerages and agents, home builders, appraisers, financial institutions that use real estate as collateral to secure loans, mortgage and title insurance companies, and government housing finance agencies. At present, there are approximately 600,000 real estate agents servicing annual sales of approximately 5 million existing homes and of 800,000 new homes. In addition to the real estate businesses involved, a buyer and a seller involved in each transaction constitute approximately 11 million additional potential customers for residential real estate information services.

Attempts have been made to improve the provision of real estate information. These efforts have been focused primarily on the residential real estate market. U.S. Pat. No. 5,636,117 to Rothstein describes a method for generating real estate market indices for use in a real estate information service. U.S. Pat. No. 5,361,201 to Jost, et al., describes a modeling process that predicts real estate sales prices and trends, and that can use neural networks to better accommodate non-linearities in market data. These patents predate the World Wide Web and lack interactivity.

Sales price prediction is essentially synonymous with valuation. Sales price prediction can rely on many types of valuation methodologies, but the most common types are comparable market analysis and trend analysis. “Comparable market analysis” predicts a sale price based on actual (“historic”) sales prices of similar properties, where “similar” has a range of meanings. “Similar” can include a geographic area surrounding a subject property, or neighborhoods with similar attributes located elsewhere in the city, state, nation, or geographic radius. “Similar” can also include physical attributes of a structure, e.g., number of bedrooms, total living area, swimming pool area, number of parking spaces, etc. “Similar” can further include proximity to certain types of infrastructure, e.g., K-12 schools, universities, public parks, freeway interchanges, libraries, etc. “Trend analysis” predicts the sales price of a property by applying algorithms, usually multiple regression algorithms, to historical times series data. The most common trend analysis uses a Least Squares Deviation algorithm.

A predicted sales price is in itself a decision tool, but the predicted sales price has been used in the securities industry as an input to additional decision tools, such as buy/sell signals. A buy/sell signal is typically generated when certain statistical conditions are satisfied. In a basic approach, buy/sell analysis could generate a sell signal if trend analysis output indicated a predicted sales price maximum for a given type of property had been reached. More advanced buy/sell signals, known in the art of securities trading, compare different two or more trend lines based on different types of moving averages, use adjustments and filtering of input data, and select different types of input data depending upon the type decision tool.

Trend information is of particular importance when zoning, infrastructure, employment, and other external factors are changing or have recently changed. Buy/sell signals, while known in the securities trading art, are rare or absent in the real property industry. One major problem confounding efforts to provide improved real property transaction information and decision tools has been inconsistencies in the types of data collected about properties in different cities, counties, or other political subdivisions. For example, there are hundreds of different types of database fields used to describe residential properties in multiple listing service database. Moreover, the types of database fields are often not consistent among multiple listing services covering properties in a single city, much less across a broader area. A second problem has been the lack of analytic tools tailored to real property transaction information. Analytic tools developed in the art of securities trading, such as trend analysis and buy/sell signals for securities, cannot easily be adapted for the real estate industry since the securities trading analytic tools depend on only a few data types, typically name of the stock or bond, date, sales price, and volume. As noted above, hundreds of different data types are used in real estate, which means that tools developed for securities transactions are grossly inaccurate when applied to real property transactions.

To further complicate the problem of improving real property transaction information and decision tools, there are many types of users of transaction information and tools. Among such users are buyers and sellers of properties; real estate brokers and brokerages; mortgage lenders; mortgage brokers; mortgage-backed securities issuers; construction companies, home owner services (e.g., landscaping, termite testing, interior design, furnishings); commercial owner services (e.g., carpeting, space layout, interior design, furnishings, janitorial); industrial owner services (e.g., waste disposal, space layout, logistics, equipment, janitorial); and insurance companies (e.g., title, fire and casualty, personal injury, mortgage). These users are found in one, two, or all of the traditional sectors of the real estate industry: residential, commercial, and industrial.

The identity of the problems causing inaccuracies in analytic tools for the real estate industry, and the delivery of transaction information and access to such tools, has been sought by practitioners in the art without success. Efforts to improve transaction information and decision tools for the residential property sector of the real estate industry have been particularly disappointing, particularly in view of the interactivity, affordability, and ease of access to information and analytic tools provided by the World Wide Web in industries other than real estate.

Today, there are some Websites, such as realestate.yahoo.com and iown.com, that enable a home seller to obtain recent sales prices. Some Websites, e.g., those at www.freddiemac.com and www.homegain.com, generate sales price predictions (valuations) that have a limited number of input variables and, consequentially, wide margins of error. Current Websites typically do not provide decision tools such as comparable market analyses, trend analysis, and buy/sell signals for real estate properties, especially combined with flexible query tools. There is unmet demand for improved real property transaction information and decision tools, particularly for residential properties.

### SUMMARY OF THE INVENTION

The inventors of the VYH invention identified the primary problems in the poor performance of existing real estate valuation services, including automated valuation services and valuation tools on Websites, as poor filtering and adjustment of raw data, a lack of data type mapping, a lack of flexibility in a user's selection of property attributes with which to generate an comparable market analysis, appraisal, or other decision tool, and a lack of sophistication in the algorithms used in the software engines generating a trend analysis, comparable market analysis, buy/sell signal, or appraisal. The VYH invention embodies solutions to those problems, and the preferred embodiment is directed toward residential property sales transactions. The VYH invention is an computerized real estate information system, and the best mode is the online system and method described herein. The scope of the invention, however, includes distribution of the output of the VYH system not only online (over a private network. over the World Wide Web, etc.), but publication of the output in other media, such as audiotext, printed publications, and video recordings.

The Value Your Home invention provides historical real estate sales information, trend analysis, comparable market analysis, buy/sell signals, and individually tailored appraisals (sales price predictions), using methods that significantly improve the accuracy, speed, affordability, and delivery of such information. The Value Your Home (“VYH”) invention sources data via a data bus or data communications network (e.g., the Internet) from one or more local and/or remote sources, e.g., Multiple Listing Services (“MLS”), real property tax records, geographic information services (“GIS”), etc., processes that information using at least one software engine, and provides information outputs and decision tools to users, including without limitation persons using Web browsers connected to the invention via a data communications network such as the Internet. The information outputs and decision tools are preferably contained in one or more display windows that the user navigates using scroll bars, buttons, and other navigation techniques known in the art. “User” means a natural person, or end-user, but also includes a process running on a computer that accept the information output of the invention for further processing.

The principal information outputs are: Historical Price Charts, Historical Price Charts—Query By Address Proximity, Geographical Information System (“GIS”) Mapping/Market Maps, Price Distribution Charts, Historical Mortgage Charts, Technical Analysis of Historical Home Price Series, Fundamental Analysis of Historical Home Price Series, Comparable Market Analysis, and Appraisals. The Technical Analysis of Historical Home Price Series and Fundamental Analysis of Historical Home Price Series information outputs include Trend Analysis and Buy/Sell Signals. The Appraisal information output includes a sales price prediction, also known as a valuation, for a subject property.

The output information is generated by the invention in response to queries formulated by users. Queries are formulated using drop-down menus and item selection, and by entry of free text in text dialog boxes, on a user interface. The user interface provides display of information outputs and decision tool outputs, entry of queries, and navigation within the VYH service. The preferred embodiment uses a Web browser as the user interface. The Web browser communicates with one or more servers that host the Value Your Home server software.

The VYH server software collects real estate, and real estate related, data from various sources, adjusts and filters the data, processes that data using trend, comparable market analysis, buy/sell signal, and appraisal engines, responds to user inputs, and provides information outputs and trend, comparable market analysis, buy/sell signal, and appraisal decision tools to users. Critical to the accuracy of the information and decision tools provided by the Value Your Home invention is the filtering, data mapping, and adjustment of raw data. Filtering of raw data primarily uses data validation techniques. Data mapping involves conforming the hundreds of different types of database fields used to describe properties in multiple listing services and other databases to a uniform naming convention. To overcome inconsistencies in the types of data collected about properties in different cities, counties, or other political subdivisions, and in different databases covering the same geographic area, the VYH invention makes extensive use of metadata (data about data) and data mapping. Data adjustments include limiting numeric values of “outlier” transactions that would otherwise distort analysis. Data adjustments also include extrapolation and interpolation of missing data items, and limitation of outliers.

The VYH trend engine uses Least Absolute Deviation multiple regression technique. Based on similar properties selected by a user from a list showing properties that have recently sold and that comply with a user's selection criteria (e.g., proximity to the subject property, number of bedrooms, total living area, and proximity to a high school), the comparable market analysis engine generates a predicted sales price for a subject property. The VYH buy/sell signal engine adapts a technique used in securities trading, called “moving average-convergence/divergence”, or “MACD”, to generate buy/sell signals. The VYH appraisal engine interacts with a user to collect data about a property for sale or a desired property, property related interests of a user (e.g., proximity to a golf course), and incorporates such user-specific and property-specific information, and trend information, in a sales price prediction algorithm to calculate an appraisal tailored to the subject property. “Engine” means a software or firmware module within the VYH invention that is responsible for a given type of data processing. The trend analysis, comparable market analysis, buy/sell signal analysis, and appraisal engines are the principal engines of the Value Your Home invention. The VYH engines are preferably implemented in software, but can be implemented as firmware. For ease of reference, the Value Your Home invention is sometimes referred to herein as the “Value Your Home server software” or “VYH server software”.

The invention can be configured and operated in various embodiments, but the two preferred embodiments are: (i) an online or Web portal, e.g., a Website primarily concerned with real property sales and brokerage; and (ii) a supplemental service for other portals, e.g., Websites primarily concerned with real estate mortgage lending, mortgage insurance, real property insurance, home furnishings, home improvements, etc. The data sources, displays, interactive dialog, analytic algorithms used in the trend analysis, comparable market analysis, buy/sell signal analysis, appraisal and other components of the invention can be tailored in embodiments to serve various user populations and one or a combination of the three traditional real estate markets: residential real estate, commercial real estate, and industrial real estate. The invention can be configured and operated for use for sales and purchases of properties, for exchanges of properties, and/or for rentals of properties. Unless otherwise indicated, the term and concept of “sales use” as used herein includes use of the invention for sales, purchases, and exchanges of properties.

### BRIEF DESCRIPTION OF THE DRAWINGS

FIG. 1 illustrates the network architecture of the VYH invention.

FIG. 2 is a flow chart of importing data from source databases to the VYH database.

FIG. 3 illustrates the first query page used with the trend engine.

FIG. 4 illustrates steps used in building the first query page.

FIG. 5 illustrates the second query page used with the trend engine.

FIG. 6 illustrates the default values of the second query page used with the trend engine.

FIG. 7 illustrates the process of data preconditioning.

FIG. 8 illustrates the relationship of Min/Max Parameter dialog boxes and data preconditioning.

FIG. 9 illustrates a page containing a sold price, volume and average price chart.

FIG. 10 illustrates the quarterly average price per bedroom of La Jolla single family homes back to 1989.

FIG. 11 illustrates a page containing the quarterly average price per square foot of living area of La Jolla single family homes back to 1989.

FIG. 12 illustrates the first query page used with the comparable market analysis engine.

FIG. 13 illustrates the top half of the second query page used with the comparable market analysis engine.

FIG. 14 illustrates the bottom half of the page shown in FIG. 13 and used with the comparable market analysis engine.

FIG. 15 illustrates a page containing the first six comparable properties found by the comparable market analysis engine within a proximity selected by the user the.

FIG. 16 illustrates a page containing a summary of the subject property selected by the user for submission to the comparable market analysis engine as part of a comparable market analysis.

FIG. 17 illustrates a page containing a “scatter chart” generated by the trend engine.

FIG. 18 illustrates a page containing a sales price distribution chart generated by the trend engine.

FIG. 19 illustrates a page containing a “per square foot” sales price distribution chart generated by the trend engine.

FIG. 20 illustrates an “age of property” sales price distribution chart generated by the trend engine.

FIG. 21 illustrates a page containing a “sales by living area” distribution chart generated by the trend engine.

FIG. 22 illustrates a page containing a “sales by bedroom” distribution chart generated by the trend engine.

FIG. 23 illustrates a page containing a simple trend line of average sales prices for single family homes.

FIG. 24 illustrates shows a page containing a predicted sales price, or appraisal, generated by the comparable market analysis engine together with statistical information.

FIG. 25 illustrates a page containing a median sales price of selected single family homes and MACD market timing indicator generated by the VYH buy/sell signals engine.

FIG. 26 illustrates a page containing buy/sell signals generated by the VYH buy/sell signals engine.

FIG. 27 illustrates a page containing an overall OFHEO price index and an index of actual home prices for the same market, as generated by the VYH trend engine.

### DETAILED DESCRIPTION OF THE PREFERRED EMBODIMENTS

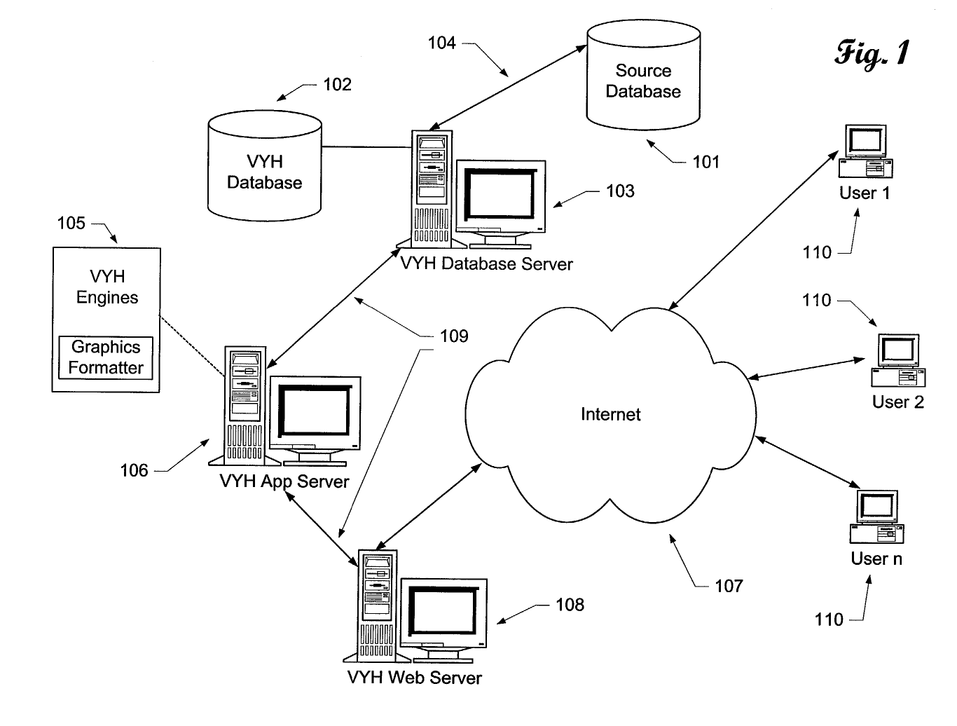

As shown in FIG. 1, the VYH invention sources data via a data bus or data communications network (e.g., the Internet) from one or more local and/or remote sources, e.g., Multiple Listing Services (“MLS”), real property tax records, geographic information services (“GIS”), etc. Typically, these sources are databases that use database architectures and data types (field names) suited to the objectives of the source database operator. MLS databases and similar databases containing real estate data do not apply uniform standards for variable names, dimensional units, temporal units, or data collected from state to state, or even from city to city in the same state. The VYH invention makes extensive use of metadata (data about data) to enable or disable the provision of certain types of information (i) to the user interface, or (ii) as inputs into the appraisal, buy/sell signals, and trend engines. For instance, information about swimming pools may be collected in one geographic region, but may not be available in another region. When comparable market analysis is performed using the invention for properties in the first region, data about swimming pools is displayed, is selectable by users, and is also used in comparable market analysis; data about swimming pools is not available for properties in the second region, and is therefore not displayed, user selectable, or used in comparable market analysis.

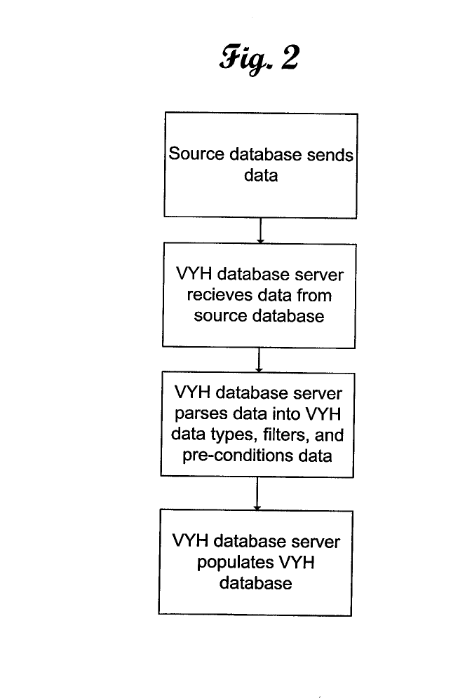

As shown in FIG. 2, exporting data from these source databases typically requires the use of a parsing engine that extracts records from a source database and converts field widths, field names, and other record attributes to the field widths, field names, and other record attributes (“VYH data types”) that comprise the uniform naming convention used by the database in the VYH invention. This process is called “data mapping”. Unless the data types in a source database are determined to match perfectly with the VYH data types used in the VYH database, data mapping is performed by the VYH server software for all initial loading and updates of the VYH database. Parsing engines, data mapping, and uniform naming conventions are known in the art, but have not been successfully applied to provide the real estate transaction information and decision tools generated by the VYH invention. After data mapping is performed, data sourced from external sources is “filtered” or validated using techniques known in the art. For instance, in data validation, a database record for the sale of an apartment with 30 bedrooms, would be detected and “scrubbed” (deleted). The uniform naming convention used by the VYH invention is a metadata procedure. A second metadata procedure is to record a binary value, Y or N, for every VYH data type used in every Level of property data. “Level” is defined below in greater detail, but is essentially the geographic area corresponding to a postal zipcode (“CityZip” or “CityZipcode”), city, or state, or equivalents of such areas in nations other than the United States. This second metadata procedure is called “preconditioning the user-selectable query parameters” and sometimes “data preconditioning”. Successful data mapping of a given datum of a given VYH data type at a given Level sets the “preconditioning toggle” for that VYH data type and Level to “Y”. Failure to data map a given datum of a given VYH data type at a given Level sets the “preconditioning toggle” for that VYH data type and Level to “N”. The preconditioning toggles provide the means for the VYH server software to enable or disable the provision of information (i) to a user interface or API, and (ii) as inputs into the trend, comparable market analysis, buy/sell signal, and appraisal engines, as a function of whether imported data has been successfully mapped into the VYH naming convention for a given VYH data type and Level.

Since VYH data types available for selection by a user are displayed or not on query pages based on the state of the preconditioning toggle for that VYH data type, and the selections made by the user on query pages form the input into the trend, comparable market analysis, buy/sell signal, and appraisal engines, preconditioning the user-selectable query parameters also preconditions the input into trend, comparable market analysis, buy/sell signal, and appraisal engines and, as a result, the decision tools generated by those engines also reflect the data preconditioning. Using data preconditioning in this manner significantly improves the accuracy and reliability of the decision tools generated by the VYH server software.

The VYH server software uses variations on a standard query and response procedure in the various query and response dialogs between the VYH server software and a user. The standard query and response procedure is based on parameter selections, specified in “real-time” by the user, that have been “preconditioned” for display to the user based on the metadata (specifically, on the preconditioning toggle for each VYH data type at each Level) that is stored in the VYH database. These standard parameters are normally presented to the user on two query “screens” or pages (in the preferred embodiment, Webpages viewed with a browser). Depending upon the particular query and response being conducted by a user, the query parameters and/or query pages used may be slightly different, but the process of metadata interrogation remains essentially the same. The query pages used to generate decision tools are almost identical, as described below.

As shown in FIG. 1, in the preferred embodiment, data to be used by the VYH engines is sourced from a source database (101) and loaded in a VYH database (102) hosted on one or more VYH database servers (103). The data communications path (104) between the VYH database server (103) and a source database (101) is typically the Internet, but optionally can be a dedicated path or virtual private network. The VYH trend, comparable market analysis, buy/sell signal, and appraisal engines (105) are hosted on one or more VYH application servers (106), and the VYH application servers are interfaced to the Internet (107) through a VYH Web server (108) hosted on one or more servers and interfaced to the VYH database server and VYH Web server by a data bus and/or network (109). Each analytic engine uses a graphics formatter, a software module that prepares graphic content based on alphanumeric or graphic component input. Each “server” can be a server computer, a cluster of server computers, server computers distributed over a local and/or wide area network. The VYH Web server is typically interfaced to the Internet, but optionally can be interfaced to a private network or virtual private network. Users are interfaced to the Web server through Web browsers on PCs (110). The VYH database uses VYH data types and uniform naming convention. In an alternative embodiment, a VYH database can also be an MLS database, which eliminates the need to source that MLS data from another database; additional data can be imported to a combined VYH/MLS database from other databases, as needed. VYH databases are updated periodically with new data from the source databases. As part of each update, data mapping, filtering, data adjustments, metadata creation and/or updates are performed. In particular, the tables that maintain the metadata are automatically updated as part of each data load or data update.

“Information outputs” are distinguished from “decision tools” in the VYH invention. An information output is factual information, such as that collected in databases of MLS services, real property tax records, geographic information services, economic data and indices, product and service catalogs, etc. The VYH server software sources such factual information, filters the information, stores the filtered data in a VYH database, and makes such information accessible to users. A decision tool is the output of one of the analytic engines that are components of the VYH server software. The preferred embodiment contains the following VYH analytic engines: a trend engine, comparable market analysis engine, buy/sell signals engine, and appraisal engine. The combination of the VYH analytic engines, the VYH database, data mapping, data filtering, and data adjustment comprise the VYH server software. The combination of the VYH server software with information server software known in the art, such as Apache Web server software or other Web server software, comprises the VYH application server. The “information server software” is referred herein as a “Web server”. The Web server relays queries and requests from users to the VYH server software, and responses from the VYH server software to users, in a manner well known in the art.

Each of the analytic engines in the VYH server software generates a variety of decision tools. Many of the decision tools are graphical charts, while others are tabular charts. The majority of the decision tools generated by the analytic engines are graphical charts.

Using query formulation and submission, a user of the VYH invention can restrict property data to be used as input to an analytic engine based on a user-selectable proximity of other properties to a subject property and one more “proximity parameters”. “Proximity parameter” means a property or neighborhood attribute, such as number of bedrooms, living area, office space area, number of parking space, existence of a swimming pool on another property, number of grade schools, number of middle schools, number of high schools, number of colleges, number of universities, number of parks, number of freeway interchanges, or other attribute of interest to the user. Query and response using a Web browser to obtain decision tools, such as trend analysis, comparable market analysis, buy/sell signals, and tailored analysis, and the ability to use proximity parameters to restrict property data input to the analytic engine generating a decision tool, is unknown in the art, including the art of the securities industry and of the real estate industry.

The VYH server software is interfaced with users by data communications paths, such as a data bus, a private network, or a public network. Users must use one of the user interfaces supported by the VYH server software. The preferred embodiment uses the Internet as a data communications path and a Web browser as the human user interface. Information outputs and decision tools are generated by the VYH server software in response to queries formulated and submitted by users. Queries are formulated using drop-down menus and item selection, and by entry of free text in text dialog boxes, on a user interface. The user interface provides display of information outputs and decision tool outputs, enables submission of queries by users, and enables user navigation within the VYH service. In the preferred embodiment, a Web browser communicates with one or more servers that host the Value Your Home server software. “Web browser” will be used generically to refer to a user interface for humans. The information outputs and decision tools are contained in one or more display windows in the Web browser that the user navigates using scroll bars, buttons, and other navigation techniques known in the art. “User” means a natural person, or end-user, but also includes a process running on a computer that accept the information output of the invention for further processing. The VYH invention may optionally contain application programming interfaces (“APIs”), which are the preferred interprocess interface; API access may be by data bus or network connection. A “VYH service” operates VYH server software. Access to a VYH service can be non-secure or secure, free or fee-based, registered user or unregistered user, depending upon the business model of the VYH service.

Using the preferred embodiment of Internet-based access by a Web browser to a Web server and associated VYH server software (“VYH Web server”), a registered VYH user uses a Web browser to access a VYH service via the Internet. In a manner known in the art, the user logs into the VYH server software via the VYH Web server, prepares a query, and submits the query to the VYH server software. The VYH Web server forwards the user requests to the VYH application server. User login data and query criteria sets are submitted to the VYH database server by the VYH application server. Login validations and query interpretations are conducted by the VYH database server against the data stored in the VYH database (query data is “pre-checked” against the query metadata stored in the VYH database). Login acceptance/rejection validation data and query result set data are extracted from the VYH database and passed to the VYH database server. The VYH database server passes the retrieved data to the VYH application server, where geocode translation and graphical display formatting is applied to the data set, and formatted into one or more HTML documents. A “geocode” is the latitude and longitude of a given property, and is used in calculating proximity to a subject property. The VYH application passes the one or more HTML documents to the VYH Web server. The VYH Web server transmits the one or more HTML documents across the Internet to the user's Web browser. The user's Web browser receives the one or more HTML documents, and displays them to the user.

A typical user navigation of the VYH information outputs and decision tools will be described next, followed by a description of the internal operation of the VYH engines and decision tools. Navigation of the VYH information outputs and decision tools is primarily done through query and response. The results returned in response to a query page that requests a list of properties available for purchase that conform with the parameter values submitted by a user is commonly called a “property search”. A property search is well known in the art of MLSs. In addition to providing query and response dialogs between a user and an analytic engine, the VYH server software can provide property searches using query and response dialogs directly with the VYH database. Interactivity with databases through query and response using a Web browser is well known in the art, including such use for property searches. Many of the inventive steps in the VYH invention lie in the types of queries and responses enabled by the VYH server software that go far beyond property searches in refinement and utility.

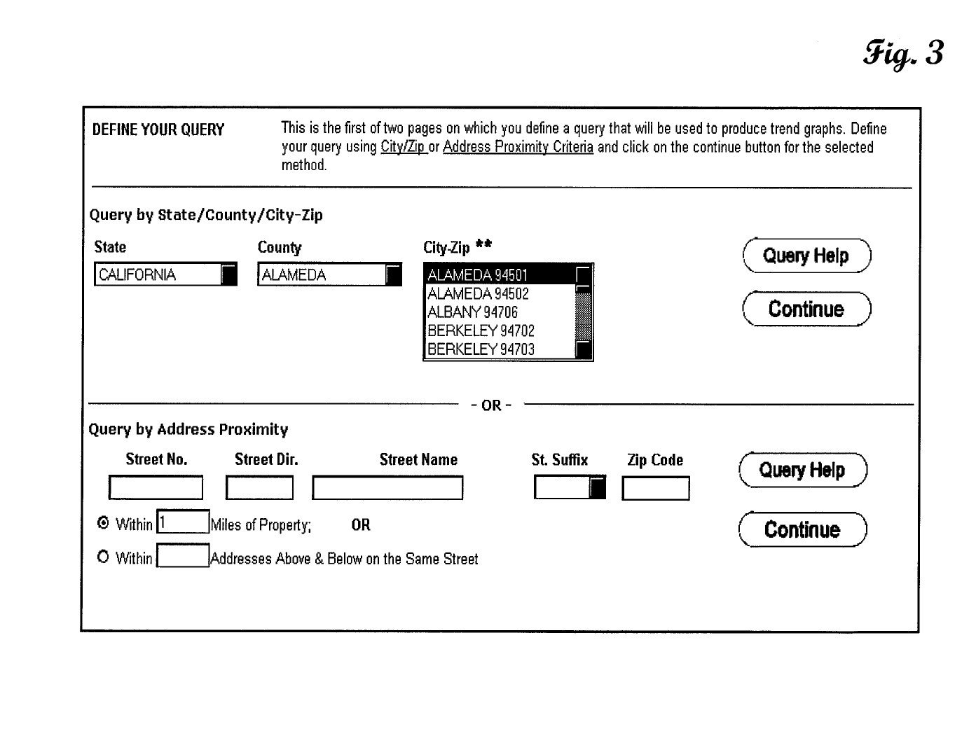

FIG. 3 shows the first page of a sales trends query presented in window or a browser by the trend engine in the VYH server software. The interactivity of the sales trend query is representative of the interactivity provided to a user in using the other decision tools in the VYH server software. This description assumes that a “subscribed user” embodiment is used, i.e., that the VYH server software has records containing information about users who have subscribed to a VYH service. A user typically accesses this page by clicking the “Tools” menu option on a root window or home page. The default tool is sales trends, a decision tool generated by the trend engine of the VYH server software. From the first page in the sales trends query, the following selections can be made:

Select a State (only populated with States that have data)

Select a County (in the selected State)

Select a CityZip, multiple CityZips, or all CityZips (within the County selected)

When the user accesses the first page of a sales trends query, the following will occur:

The user record is interrogated to determine the user's “default” state, province, or other political subdivision.

The State table values are used to populate the State dropdown list (must exclude states whose State table's date column value is blank).

The user's default State is shown in the dropdown box.

The County table values associated to the selected state populate the County dropdown list (but Counties whose County table's earliest date column value is blank are excluded). The first County is shown alphabetically in the dropdown box.

The CityZip table values associated to the first County are displayed in the CityZip scrolling list box, sorted alphabetically on City name, and must exclude CityZips whose CityZip table's earliest date column value is blank). (The names in this list are created by concatenating City name, a space, and CityZip). The CityZip name list includes an “All” entry, which should be first in the list, and highlighted (selected) on initial load.

The user message buffer (shown with a dotted line) will state either:

“Welcome to Value Your Home, (User First Name)”. This is the “standard” message, or

“Hello, (User First Name). For uninterrupted service, your subscription should be renewed before (Paid-Through Date)?” This message is determined by 2 data elements: the user's “Paid-Through Date”, and a “Renewal Reminder Days” number (displayed during registration/renewal period for a user).

The content of user messages can be created dynamically based on the value of variables specific to a given user or to a given search. For example: Paid-Thru=4/30/00; Reminder Days=7; starting on 4/24/00 . . . Message is: “Hello, Robert. For uninterrupted service, your subscription should be renewed before May 1.”

A user can only select one State or one County from the respective list boxes. This “on-click” action triggers a page refresh and reloads the page as described above for the new State or new County (within the State) selected. After selecting entries in the scroll boxes and clicking “Continue” on the first page of the sales trends query, as described above, the user is taken to the second query page. This first query page enables the user to select a Level, subject property, and proximity. The ability to use a proximity search based on addresses above and below the address of the subject property is novel.

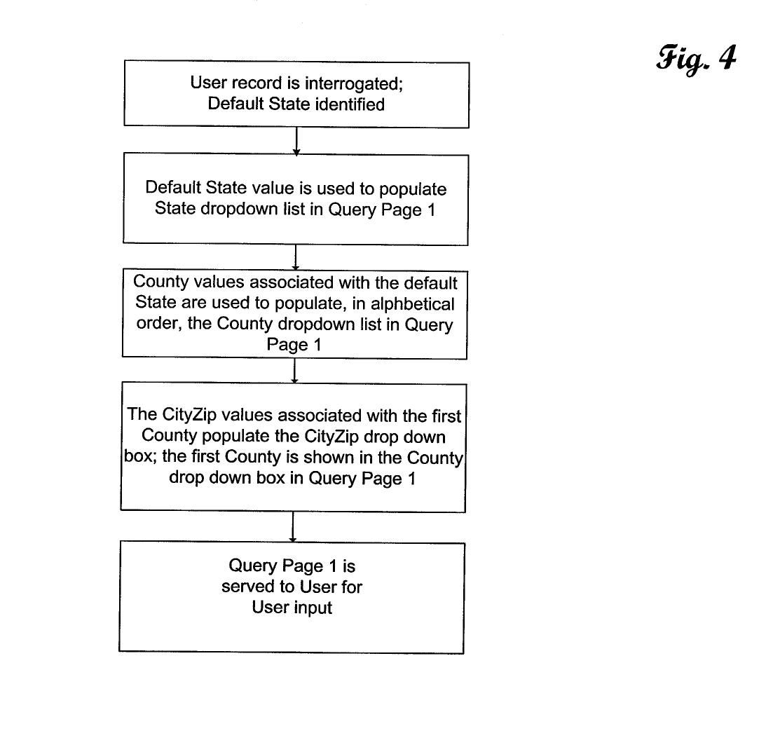

As shown in FIG. 4, the first query page is prepared based on the contents of a given user's preferences as stored in a user record in the VYH database. The default State and search proximity values are retrieved from the user record and used to populate the State dropdown list and the proximity box. Based on the State value, County values for that State are retrieved from a VYH database table and used, in alphabetical order, to populate the County dropdown list. Based on the first County in the County dropdown list, the CityZip values for the first County are retrieved from a VYH database table and used to populate the CityZip dropdown list, and then the first query page is served to the user. Since many users are real estate salespersons, defaulting the search to the State in which the user does most or his or her business speeds serving of the first query page to the user.

As data updates are “imported” and loaded into the invention database, each property sales (or financing) record is interrogated to determine its data characteristics (e.g., property type, zip code, pool inclusion, dwelling size, sales date, etc.). Based on individual data elements in the property sales record, metadata indicators are “set” within the Level tables of the VYH database, e.g., CityZip table (i.e., the “lowest” tier of the 3-tier geographical query/search hierarchy of State, County, and CityZip). A database trigger is then used to update the County Level, which is the middle geographic region (i.e., the County in which the CityZip of the relevant property is located), and another database trigger is then used to update the highest level geographic region of State (i.e., the State in which the County of the relevant property is located). Different labels are used for the three Levels, depending on the country. For example, in Canada, the three Levels would be postal code, county, and province. In the U.S., some regions may use “township” instead of “county”. The metadata corroboration techniques used in the VYH invention provide a user benefit of drastically limiting the number of times that a submitted search query will yield “no data”.

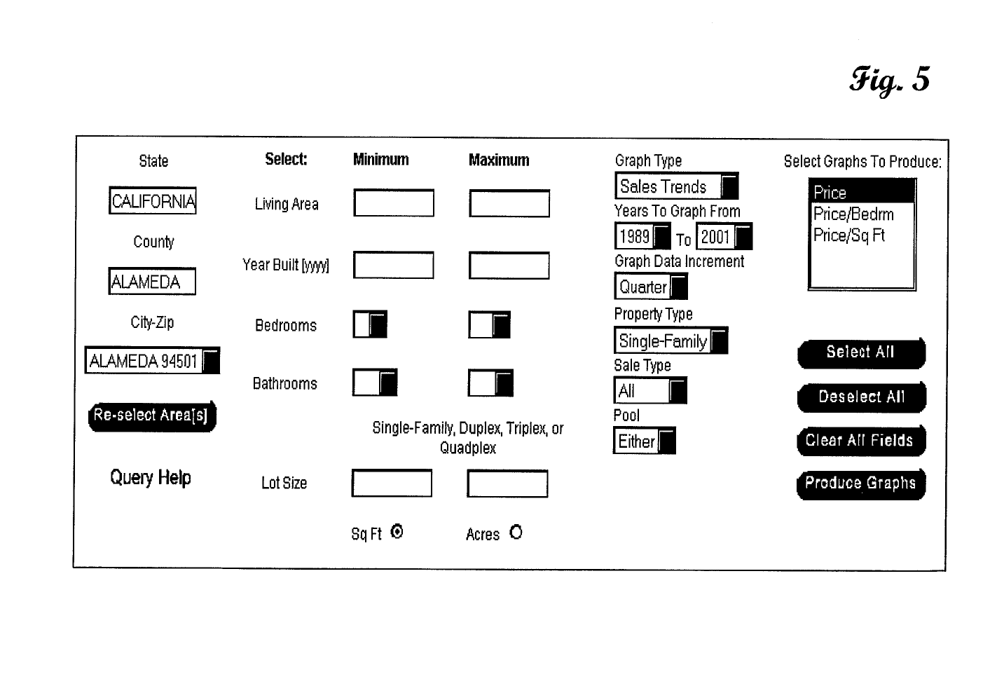

As shown in FIG. 5, in the second page of the sales trends query, the user can select parameters to use in the query being formulated. If a user clicks the “Reselect Area” button on the second query page to return to the first query page, the page displays whatever was on the first page when the user clicked the “Continue” button (i.e., the “first time” access/load routine is not performed).

In the second page of the sales trends query, the State and County boxes are display-only and will bear the name of the selected State and County, from the previous page. The City-Zip scrolling display box lists each City-Zip name that was selected on the previous page.

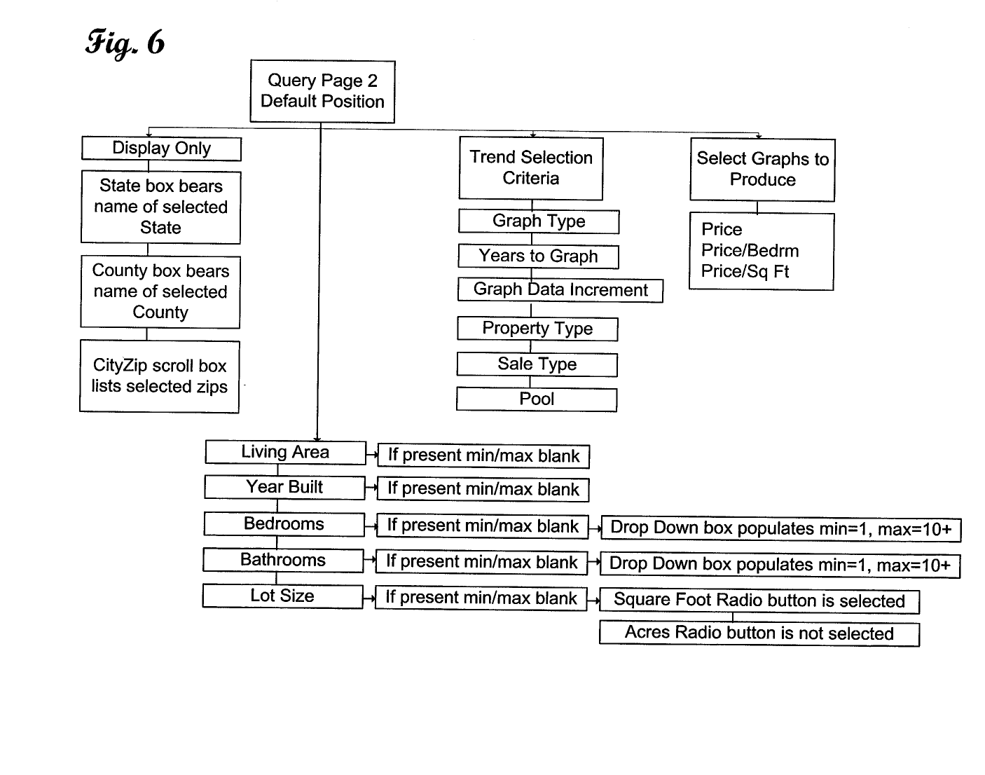

FIG. 6 shows the default values of the second query page. Defaults for the second page of the sales trends query are:

Living Area (see discussion below) If this item is present (i.e., the preconditioning toggle value for this VYH data type and Level is Y), min and max values are blank.

Year Built (see discussion below) If this item is present, min and max values are blank.

Bedrooms (see discussion below) If this item is present, min and max values are blank, min=1, max=10+

Bathrooms (see discussion below) If this item is present, min and max values are blank, min=1, max=10+

Lot Size (see discussion below) If this item is present, min and max are blank, and Sq Ft radio button is highlighted (selected), Acres radio button defaulted not selected.

Graph Type=Sales Trends

Years to Graph From=(see discussion below)

Graph Data Increment=Month

Property Type=Single Family (see discussion below)

Sale Type=All (if Graph Type is reselected to another type, i.e., Mortgage Info, the text associated with this dropdown becomes “Financing Type”, and the data that populates the dropdown list changes; see discussion below)

Pool—Either (see discussion below).

The VYH server software uses metadata extensively to condition data fields, labels, and dropdown list boxes. Input fields (and associated labels) and some table values loaded into dropdown lists on the second page of the sales trends query are based on database parameters associated with the Level selected. Determining how to “condition” fields and dropdown values in the second page of the sales trends query is dependent upon what the user specified on the first page of the sales trends query as the lowest selected level of area hierarchy. Each type of defined geographic area, usually a governmentally defined geographic area such as a postal zipcode (“CityZip”), city (“City”), county (“County”), or state (“State”), is a level (“Level”) in a given hierarchy of such areas. If one or multiple CityZips have been selected, the data values in the CityZip table rows associated to the selected CityZips is used. An example:

State selected=State X

County selected=County Y

County Y has 3 CityZip entries (1, 2, and 3)

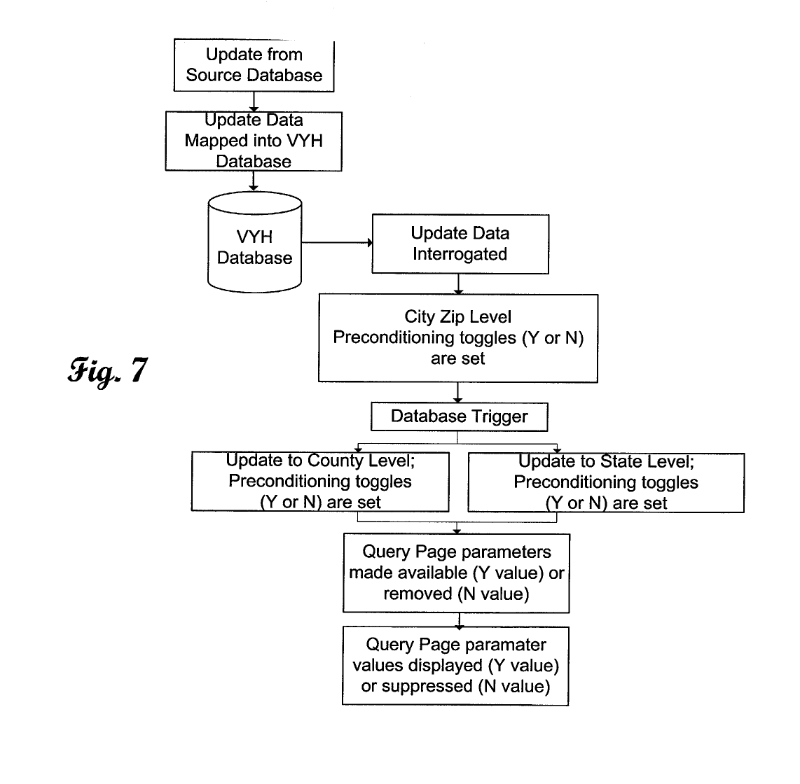

As shown in FIG. 7, the VYH database is periodically refreshed with updated data from source databases. As used herein, “YN” means a value of either Y (data exists at a given Level in the VYH property database) or N (data does not exist at a given Level in the VYH property database) is possible for a given parameter. Y and N values are mutually exclusive for a given VYH data type are at a given Level, and are the permitted preconditioning toggle values for each VYH data type at each Level. Y or N toggle values determine whether display of the relevant parameter is possible (value of Y) or not (value of N). As described above, a YN value is stored for each VYH data type at each Level in the VYH database. During initial data load and periodic VYH database updates, the State, County, and CityZip tables are automatically updated. If any property in CityZip 3 includes a Living Area value, the “Has Living Area Indicator” in CityZip 3's database record gets set to “Y”. A trigger then updates County 1's, and State 1's corresponding “Has Living Area Indicator” values to “Y”. If the user has selected State 1, County 1, and all CityZips within County 1, then County 1's “Has Living Area Indicator” value is used to condition the Living Area min/max formatting (i.e., show these fields and labels if “Y”; do not show these fields and labels if “N”). If the user has selected State 1, County 1, and CityZip 3, 4, 20, and 22, then, if either CityZip 3, 4, 20, or 22's “Has Living Area Indicator” preconditioning toggle value equals “Y”, the Living Area fields and labels would show; otherwise they would not show.

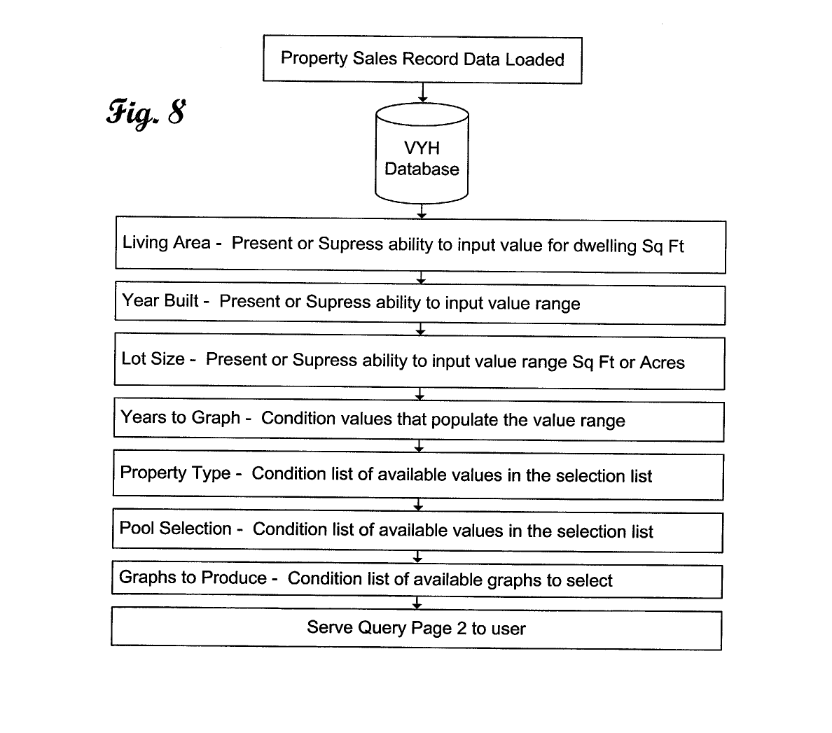

As shown in FIG. 8, dialog boxes on query pages used to submit queries to the VYH database (i.e., for a property search) or to analytic engines in the VYH server software, including query pages that drive the trend engine, include a user-entered range of numeric values for a given parameter (“Min/Max Parameter”). FIG. 8 illustrates the relationship of Min/Max Parameter dialog boxes and data preconditioning. Typical Min/Max Parameters are:

Living Area—If the preconditioning toggle at the selected Level is set to N, then this label and its minimum and maximum input fields are not displayed.

Year Built—If the preconditioning toggle at the selected Level is set to N, then this label and its minimum and maximum input fields are not displayed.

Bedrooms—If the preconditioning toggle at the selected Level is set to N, then this label and its minimum and maximum input fields are not displayed.

Bathrooms values—If the preconditioning toggle at the selected Level is set to N, then this label and its minimum and maximum input fields are not displayed.

Other Parameters that can be used to restrict the property data submitted in a query are:

Lot Size (either Sq Ft or Acres)—this is operational only when one of the following “Property Types” is selected: Single Family Residence, Duplex, Triplex, Quadplex. A warning is displayed to the user, “Only for Single-Family, Condominium, All Multi Fam, MF-Duplex, MF-Triplex, MF Units 2-4, MF-Quadplex”. The Lot Size YN variable is associated with Levels (County or CityZip). If the Lot Size YN variable is “N”, then this label, its minimum and maximum input fields, and the Sq Ft and Acres radio buttons are not displayed on the page presented to a user.

In all query pages generated by the VYH server software, the following special formatting notes apply:

Bedroom dropdown list values are 1 to 10, and 10+ (with 10+ indicating highest value in database).

Bathroom dropdown list values are 1 to 10 in ½ steps, with highest value=10+ (e.g., 1, 1½, 2, 2½, etc., ending with 10+, implying to the highest value in the database).

Years to Graph From: From “Year=” in the dialog box on the first query page, insert the earliest date value in the database table column, (for the “lowest selected Level” specified by the user on the first query page) and present a 4 digit year as the initial year in which data is available; To Year=Current Year. The “From Year”, then, is the year contained within the user specified “lowest selected Level” without being earlier than the date of the earliest property sale in the VYH database.

Graph data increment values (x-axis, y-axis increments) are normally maintained in a dedicated table, such as a page table, in the VYH server software, rather than in the property database. The typical menu options in a dropdown “period” list are: Month, Quarter, and Year. The Graph Type is Populated from the rows of the Graph-type table; the rows are associated to the Graph-view (or Views) the user has subscribed to (as maintained via an associated table). The available graph list should display in the order below (subject to conditioning by the preconditioning toggle values). The list items below are based on the “lowest selected area” specified by the user on the first query page.

For illustration, assuming that the Property Type default is “Single Family”, the typical menu options in a dropdown “Property Type” list are (assuming the preconditioning toggle values in the associated CityZip or County table column is Y for each VYH data type in the list items below):

Single-Family

Condominium

MF—All Multi-Family

multifamily Duplex

multifamily Triplex

multifamily Quadplex

multifamily from 2 to 4 units

multifamily 5 or more units

Pool (dropdown list display in the following order)):

Yes

No

Either

(If the Pool value at the user-selected Level is “N”, then the Pool label and dropdown menu are not displayed. If the Pool value at the user-selected Level is “Y”, then label displayed defaults to “Either” and allows the user to select from the immediately preceding list).

Sale Type—This is dependent on the decision tool selected. If the selected decision tool is Sales Trends generated by the trend engine, the label for this dropdown is “Sale Type” and the following menu options are provided on the Sale Type dropdown list:

| | |
|---|---|
| New | S |
| Resale | R |

All (if “All” is selected, the “Sale Type” is ignored in query. The default value is “All”).

If the decision tool is “Mortgage Stats” generated by the trend engine, the label for this dropdown list is “Financing Type” and has the following list values:

| | |
|---|---|
| New | S |
| Resale | R |
| Refinance L | |

All (if “All” is selected, the “Financing Type” is ignored in query. The default value is “All”.)

If the decision tool is “Single Lender” generated by the trend engine, the label for this dropdown list is “Financing Type” and has the following list values:

| | |
|---|---|
| New | S |
| Resale | R |
| Refinance L | |

All (if “All” is selected, the “Single Lender” is ignored in query. The default value is “All”.)

Continuing with using the user navigation and tailoring of the decision tools generated by the trend engine as an illustration of the user navigation and tailoring of the other analytic engines in the VYH server software, after the first two query pages are submitted by the user, the VYH trend engine requests the user to select a specific type of decision tool by presenting the “Select Graphs To Produce” page. A user (as found in the User table stored in the VYH database) may subscribe to one or more Graph-view rows. Subscription is recorded via entries in rows in an associated table, called “Graph-view”. Each Graph-view row relates to one or more types of graphical decision tools, or “Graph types”. Possible values for the “Select Graphs to Produce” list, dependent upon the Graph-view or views to which the user has subscribed, are:

Graph Views

Consumer

Graph Types

Sales Trends

Graphs

Price
Price/Sq Ft
Price/Bedroom

Mortgage Stats

Graphs

Average Price & Loan
Loan-To-Value
Mortgage Type
Top 5 Lenders

Single Lender

(When “Single Lender” is selected by a user, the VYH trend engine populates the scroll box “Select a Lender to Produce” with a list of all lenders that are active in the selected Level. Using menu options on a dropdown list, the trend engine can also sort lenders by Lender Name and Lender Volume.) Once a Single Lender is selected, four graphs are automatically generated by the trend engine and displayed on the “Consumer View” interface:

Price & Mortgage Amount

Loan-To-Value

Type of Mortgage

Mortgage Volume

Similar Single Lender graphs are available in the “Business View”:

Graph Types

Single Lender

Graphs

Price & Mortgage Amount

Loan-To-Value

Type of Mortgage

Mortgage Volume

By control-key/clicking (or equivalent) graph types in the relevant scroll box, a user may select one or more of the graphs that are available for the View-type (consumer, business, or both) the user has subscribed to. Since available graphs can change over time, and will be different from Consumer to Business user type, graph names are typically not hard-coded in a user selection page. A user can also control the operation of selections in the Graph Views page as follows:

The Select All and Deselect All buttons select all, or deselect all, respectively, graph types in the list of available graphs to produce.

The Clear button clears all data from the query form (except for the Level information, e.g., State, County, CityZip).

Many tax databases enter land/lot area in square feet; in some regions of the country, and some MLSs, enter lot size as decimal acreage. An “acres” radio button is provided on query pages, and if selected by the user, the VYH server software provides lot size in acres. The VYH server software validates query pages to ensure that that both “sq. ft.” and “acres” have not been selected by a user.

The user's clicking “Produce Graphs” on the second page of the sales trends query causes the VYH trend engine to generate and display the decision tools selected by the user. The pages that comprise the decision tool, e.g., sales trend graphs, can be presented on a single page, and as a series of hyperlinked pages.

The decision tools produced by the trend engine are as follows.

The Historical Price Charts decision tools are:

For individual states, counties, cities, municipalities, zip codes, or census tracts:

Charting home sold price and monthly sales volume over time

Charting home sold price per square foot of living area over time

Charting home sold price per square foot of lot area over time

Charting home sold price per bedroom over time

Charting average or median age of homes sold over time

Charting average or median size (e.g. living area, lot area, or bedrooms) of homes sold over time

Historical Price Charts—Query By Address Proximity

All of the “Historical Price Charts” described immediately above are generated by a query of data in a given radius or rectilinear distance around a subject property.

The Geographical Information System (“GIS”) Market Maps decision tools are:

For individual states, counties, cities, municipalities, zip codes, or census tracts:

Charting average or median home prices for different states on a map color coded by price

Charting average or median home prices for different counties on a map color coded by price

Charting average or median home prices for different zip codes on a map color coded by price

Charting average or median home prices for different cities or municipalities on a map color coded by price

Charting per zip code on a map color coded by range reflecting:

Average Single Family Sold Price

Number of Single Family Sales

Total Single Family Sales Volume

Average Single Family Price Appreciation Rate Between specified dates

Average Single Family Sold Price Per Square Foot Of Living Area

Average Single Family Sold Price Per Bedroom

Average Age Of Single Family Homes Sold

Showing the above GIS charts as a time sequence, e.g., where the colors change over time to show increasing or decreasing prices

The Price Distribution Charts decision tools are:

For individual states, counties, cities, municipalities, zip codes, or census tracts:

Charting average or median home sold price distribution (i.e. number of sales by price range)

Charting average or median home sold price per square foot distribution (i.e. number of sales by price range)

Showing the above price distribution charts as a time sequence, e.g., where the distribution changes over time

The Historical Mortgage Charts Decision Tools are:

For individual states, counties, cities, municipalities, zip codes, or census tracts:

General Mortgage Statistics

Charting average or median home price and mortgage amount over time

Charting average or median mortgage loan-to-value ratio over time

Charting average or median mortgage by type (fixed vs. variable) over time

Charting average or median mortgage volume by top lenders (market share) over time

Single Lender Mortgage Statistics

Charting individual mortgage lender monthly average or median home price and mortgage amount over time

Charting individual mortgage lender average or median loan-to-value ratio over time

Charting individual mortgage lender monthly average or median mortgage by type (fixed vs. variable) over time

Charting individual mortgage lender loan volume over time

The Technical Analysis of Historical Home Price Series decision tools are:

For individual states, counties, cities, municipalities, zip codes, or census tracts:

Charting the price and a “best fit” trend line

Charting the price and a “smoothness priors” line

Charting the price and various moving averages

Charting the price and the Relative Strength Index

Charting the price and the moving average-convergence/divergence (“MACD”) index

Charting the price and On Balance Volume

Charting the price and Money Flow Index

Charting the price and percent change (e.g. annual)

Charting the price and volatility bands

Providing Time Series forecasts of monthly prices

Charting the price and the above technical indicators in a histogram

The Fundamental Analysis of Historical Home Price Series decision tools are:

For individual states, counties, cities, municipalities, zip codes, or census tracts:

Charting the employment growth

Charting the unemployment rate

Charting the new construction as measured by the number of building permits issued

Charting the trends in median rents

Charting the rental vacancy rate

Ranking and charting price performance (e.g. quarterly or annual percent change) in a histogram

Ranking and charting fundamental performance (e.g. quarterly or annual percent change) by population, employment, total personal income, building permits

Developing a search screen to rank by price performance and fundamental performance

Graphically correlating monthly price and fundamental factors (e.g. employment, population, total personal income)

Depending on the data preconditioning (preconditioning toggles set for each VYH data type at each Level), in building the second page of a sales trend query, the VYH trend engine will make available or remove dialog boxes (i.e., labels and query parameter input fields) from the second page. For example, if a data source does not support, report, or track the living area of dwellings in a geographic region, and the user specifies a query within that geographic regions, when the second query page is presented, a dialog box in which a user may specify a range of values for living area is not presented to the user. Also, in this example, decision tools that require square footage or other area measurement to have meaning (e.g., a graph of Price Per Square Foot Living Area) are not presented to the user. If a metadata value of N exists for a give VYH data type, values within dropdown lists or other types of parameter selection lists for that data type will be suppressed. For example, if, within a geographical area specified by a user, whether State, County, and CityZip(s), there are no “Duplex” properties in the database, when the second query screen is presented, the “Duplex” entry in the Property Type dropdown selection list will be deleted or greyed out from the list of selectable values.

The VYH server software caches queries, and the response generated by a query, for a period of time (“cache period”) selected by the operator of a VYH service. By accessing cached queries and responses, the VYH invention accelerates the provision of responses when the same query is received within the cache period.

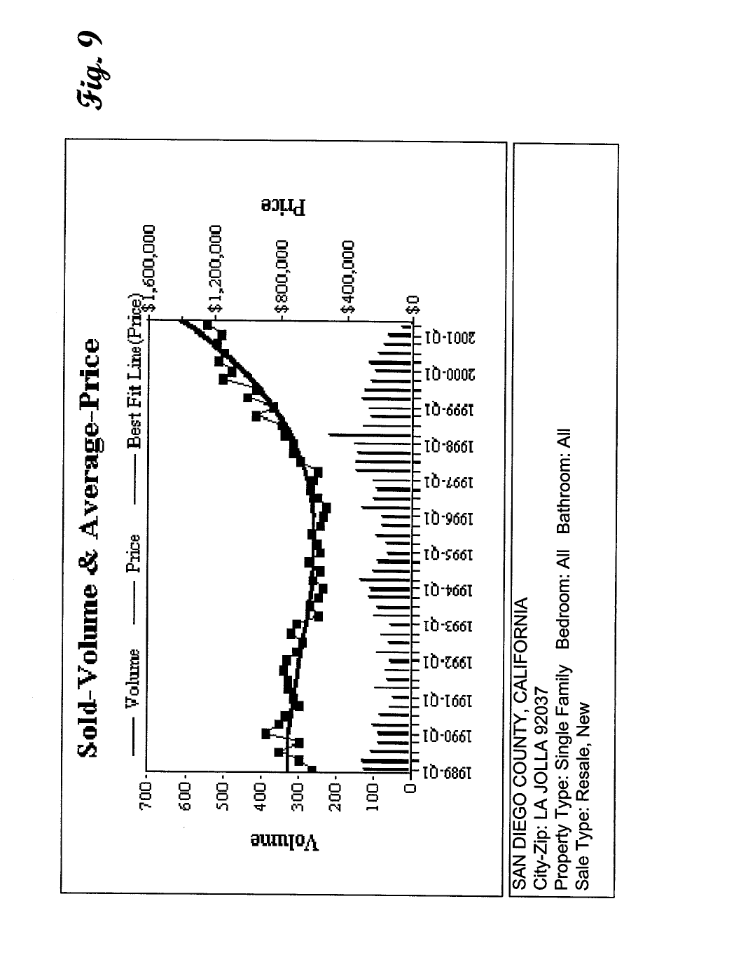

As shown in FIG. 9, real estate price charts are shown in a format similar to a typical stock market chart. The sales price is denoted by the continuous line and is referenced by the left or right y-axis while the sales volume is denoted by the vertical bars on the bottom of the charts and is referenced by the other y-axis. VYH price charts show average (or median) user-selectable quarterly or monthly “sold prices” along with the number or volume of quarterly, monthly, or weekly sales. In contrast, the typical stock chart shows daily data of the price and the volume of shares traded. There are several reasons for the difference in x-axis increments (time periods) between stock price charts and the VYH real estate price charts. First, is that real estate markets generally move in longer time cycles than do financial markets so a longer time frame is more appropriate. Second, is that there generally are not real estate transactions occurring everyday as there are with financial markets so it would not be possible to create daily charts.

Other than these differences, the interpretation of the information presented in the real estate and stock market charts is very similar. In particular, prices will generally follow volume with a time lag. This is because sales activity or volume is the fuel behind price movements. This is much the same way that pushing the gas pedal on a car causes it to speed up, an increase in sales volume will cause price to move up. This move will continue until the volume decreases in the same way that a car will slow down when the driver takes his foot off the accelerator.

In the case of real estate values, the lag between volume and prices is typically between 6 and 24 months. The range is a function of how many properties were on the market when volume began increasing. Unlike the financial markets, the real estate market has historically been quite inefficient. This can be traced to several factors including (1) the difficulty in getting timely and accurate data on real estate prices and sales activity, and (2) the lack of daily or, sometimes, even monthly or quarterly price discovery. Price and volume data are primary inputs to VYH trend engine.

FIG. 9 is a representative decision tool generated by the trend engine in the VYH server software. FIG. 9 shows the quarterly average sold price and number of sales of La Jolla single family homes back to 1989. The high levels of sales activity, which culminated in 1989, led to a sharp run-up in prices from approximately $600,000 to $800,000 by 1990. Thereafter, sales dropped off sharply in 1990-91 and remained at relatively low levels until 1997. The decline in sales activity led to a steady deterioration in prices such that, by the market's bottom in 1996, prices had retraced much of their gains of the late 1980s. A significant increase in sales activity, which began in 1997, laid the foundation for the most recent upswing in prices. Between 1996 and 2000, the average La Jolla single family home experienced more than doubling in price.

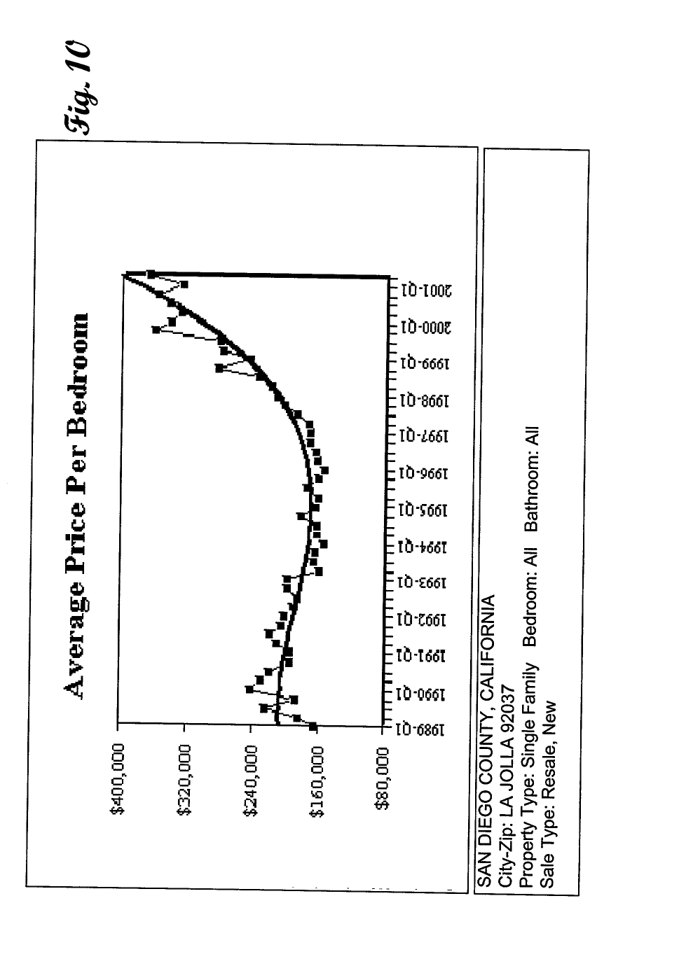

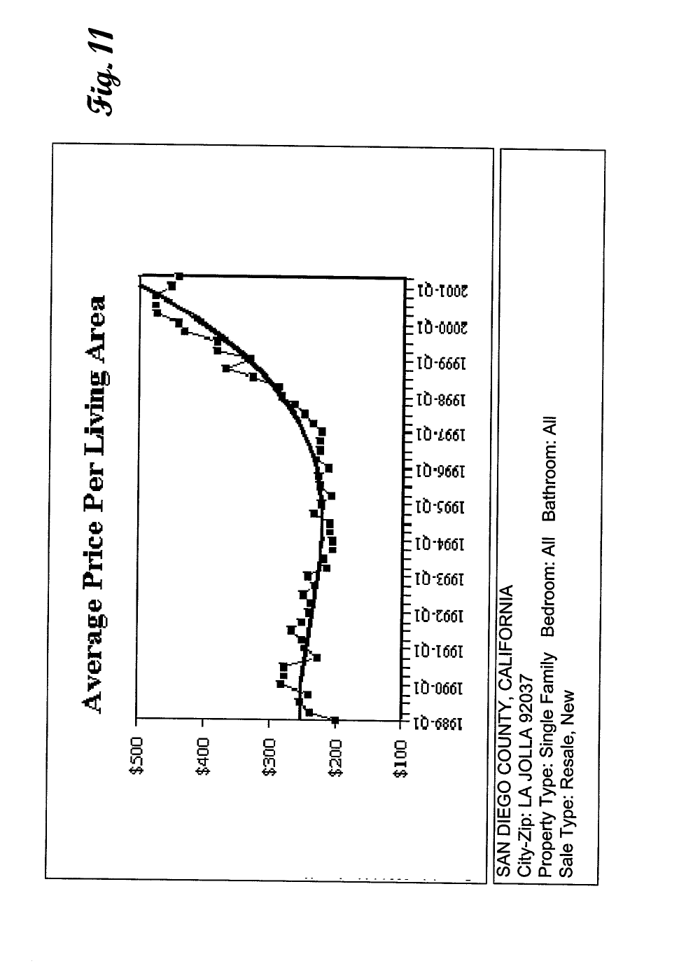

FIGS. 10 and 11 are a representative decision tools generated by the trend engine in the VYH server software. FIG. 10 shows the quarterly average price per bedroom of La Jolla single family homes back to 1989, and FIG. 11 shows the quarterly average price per square foot of living area of La Jolla single family homes back to 1989.

There are a number of ways to look at real estate prices. Generally, home prices are directly related to the size of the property—in particular, the greater the number of bedrooms or lot area of the home, the higher the price. This is the primary reason why sales prices in a neighborhood may show a wide spread of values. However, these same sales, when looked at on a per-bedroom basis, will generally show a much smoother and more consistent pattern. In most cases, this allows for a more meaningful evaluation and comparison of property values. The per-bedroom price is sales price divided by the number of bedrooms of the subject property.

Trend charts for residential property sales allow for quick estimates of a home value in a particular zip code or neighborhood by taking the recent price per square foot and/or price per bedroom and multiplying by the respective living area values of the subject property. In addition, it is easy to see from the VYH trend charts the typical range of values of price, price per square foot, and price per bedroom that may be found in a neighborhood by inspecting the “volatility band” of the charts. As shown in FIG. 9, the volatility band refers to the “closed sale” data points above and below a trend line.

In conjunction with process of generating the decision tools, a “data filtering” process is performed (i) to ensure that a sufficient number of properties are present to create statistically valid trend lines in the graphs produced by the invention (i.e., the data filtering process ensures that the number of properties retrieved in response to submission of a query parameter set is sufficient to produce a statistically meaningful graph); if the retrieved property count is less that the threshold count for a statistically meaningful trend line, a graph or graph set will not be generated; and (ii) to remove properties that have excessively high or low data values within key data elements, such as sales price. Each “closed sale” data point used in the sales price prediction algorithm affects the predicted sales price. The analytic engines of the VYH invention can filter data values for a given data type by discarding abnormal, or “outlier”, data values that are outside a reasonable range, or by limiting their deviation from a reference, such as a trend line. For example, if a hundred properties sold in a geographic area within a certain timeframe, and all were sold at a price that ranged between X and 3X dollars, a lone property that sold for 8X dollars can be deleted (“scrubbed”) or limited to a maximum deviation from the relevant trend line, even if it is a valid record, since the statistical deviation created by an abnormal, or “outlier”, sales price negatively impacts predicting the probable sales price for the subject property.

The deviation from a trend line that causes scrubbing or limiting of outlier data points can be set by the operator of the VYH service. In the preferred embodiment, the following data filtering is performed: (i) for individual sales, the filtering process excludes properties that are part of a multiple parcel sale, or that have sales prices of less than $20,000.00 or greater than $9 million; (2) individual closed sales data points that deviate more than 25% above or below the immediate prior value are limited to a 25% deviation from the prior value. For example, if the prior value is $100,000 and the next data value is $150,000, the “deviation limiting” the latter value at $125,000. If there is no value for a particular month, quarter, or year, the trend engine interpolates between the values on either side of period without data. For example, if the price for the first quarter is $100,000 and there were no sales in the second quarter and the price for the third quarter was $120,000, the trend engine sets the price for the second quarter to $110,000. If there is no value for the first point of a trend line chart, the trend engine extrapolates backwards from the next two values. For example, if the trend line chart starts in the first quarter of 1995 and there is no data for that quarter, the trend engine takes the slope of the line between the second and third quarters of 1995 and projects a value for the first quarter; if the second quarter of 1995 data point is $110,000 and the third quarter of 1995 data point is $120,000, then the trend engine sets the first quarter of 1995 value to $100,000. In the trend charts, the trend engine plots a third order polynomial which is calculated using a “best fit” least squares technique.

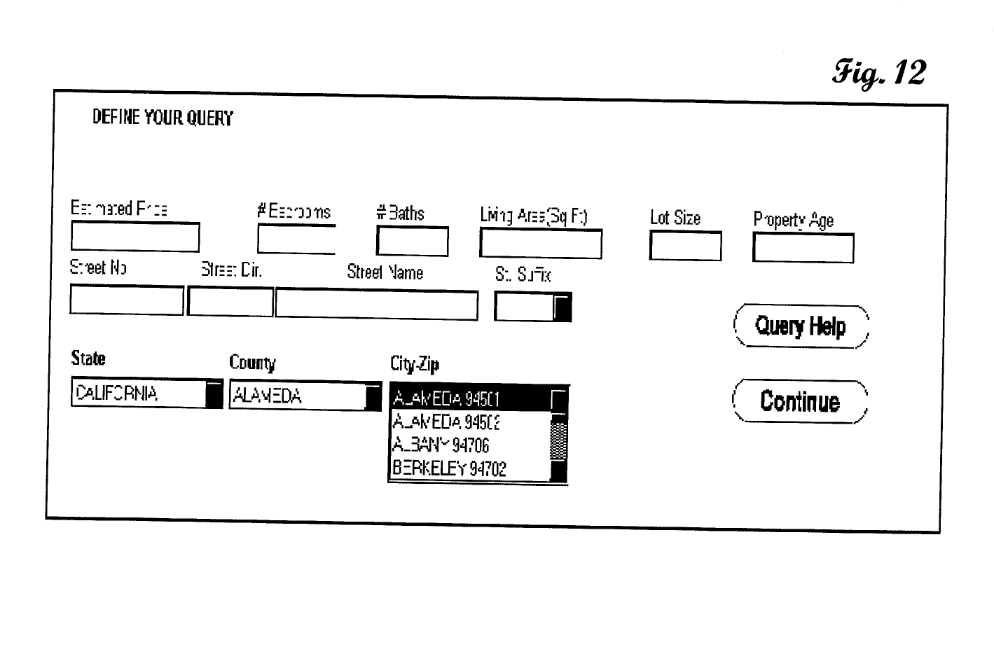

As shown in FIGS. 12 through 14, to generate a comparable market analysis, the user completes and submits query pages similar to the ones generated by the trend engine and selects properties from a list showing properties that have recently sold and that are within a user-selectable radius or rectilinear distance from the subject property. Optionally, other proximity parameters can be used to restrict the property data submitted to the comparable market analysis engine. After entry of data, the VYH comparable market analysis engine applies algorithms that weigh the key features of the subject property versus the features of the comparable properties to provide an estimated appraised value (predicted sales price) for the subject property. In the comparable market analysis engine, data regression algorithms and similar techniques are used that allow the prediction of the sales price of the subject property, based on data related to actual sales of similar properties within a user selectable geographic proximity range to the subject property, and within an user selectable sales-date time range (relative to the date of the user's query).

FIG. 12 shows the first query page used to prepare a query for submission to the comparable market analysis engine. This first query page enables the user to select a Level, property attributes, and subject property address.

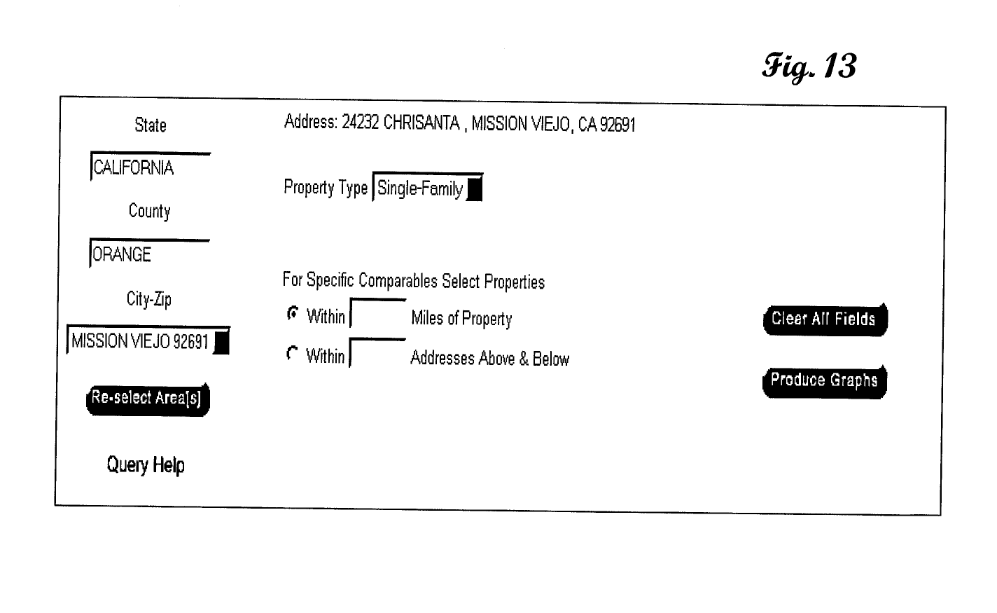

FIG. 13 shows the top half of the second query page used to prepare a query for submission to comparable market analysis engine. This page enables the user to select similar properties as input to the comparable market analysis engine. The ability to use a proximity search based on addresses above and below the address of the subject property is novel.

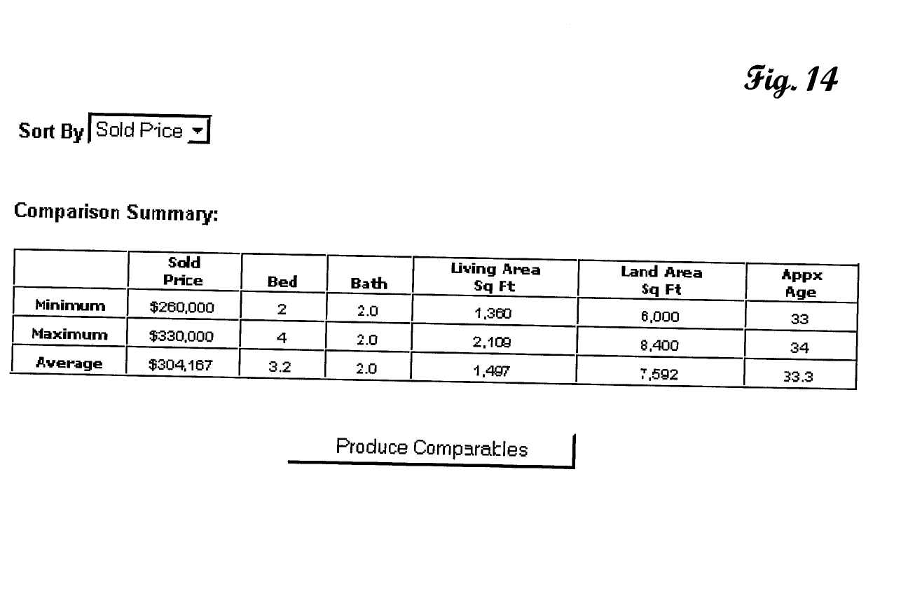

FIG. 14 shows the bottom half of the page shown in FIG. 13 and generated by the comparable market analysis engine. The page reports the minimum and maximum values for the parameters selected by the user in the comparable market analysis query pages, and the average values of the parameters of the properties selected by the user as input to the comparable market analysis engine. Clicking “Produce Comparables” submits the query to the comparable market analysis engine.

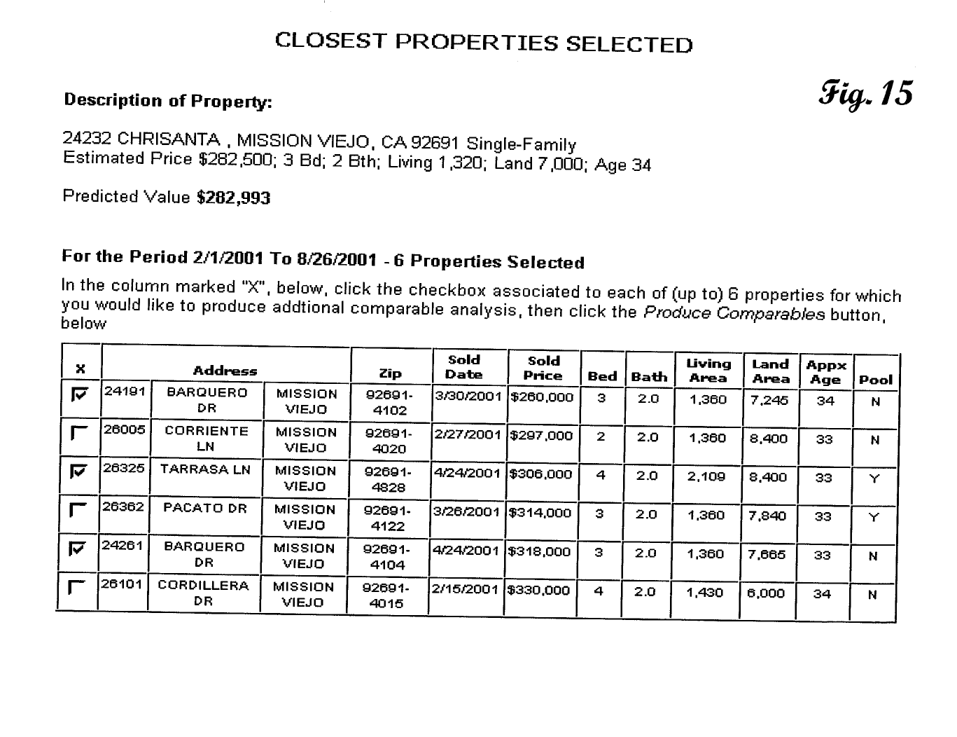

FIG. 15 shows the page containing the first six comparable properties found by the comparable market analysis engine within the proximity selected by the user. The user selects up to 6 properties to include in the comparable market analysis and submits them for comparison with the subject property identified at the top of the displayed page.

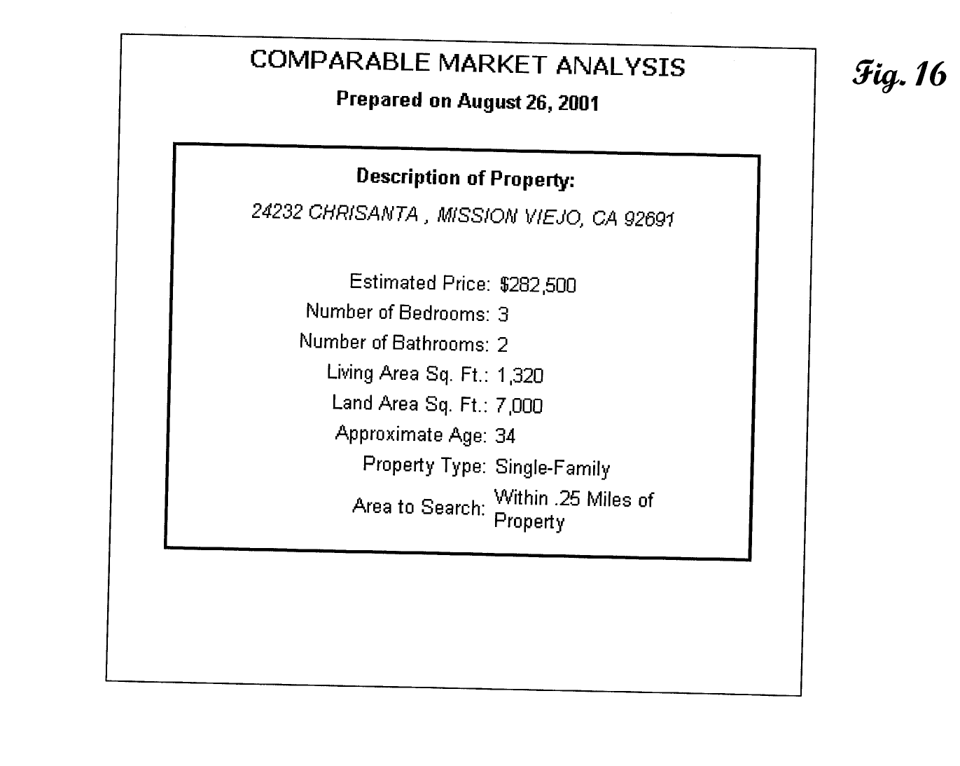

FIG. 16 shows a summary of the subject property selected by the user for submission to the comparable market analysis engine as part of a comparable market analysis.

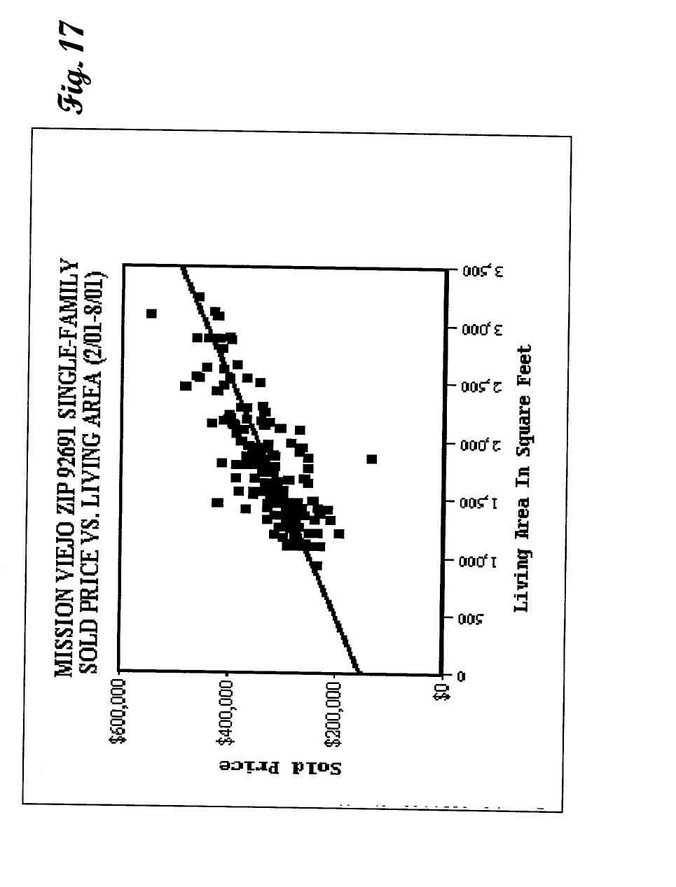

FIG. 17 shows a “scatter chart” generated by the comparable market analysis engine in the VYH server software. Each point in the scatter chart corresponds to a sale in the vicinity of a subject property selected by a user using VYH query pages. The individual sales are plotted such that the living area of the home is found on the horizontal axis and the sales price is on the vertical axis. A “best fit” line has been drawn through the sale points to best see the strong relationship, which typically exists, between the size of a home and its value.

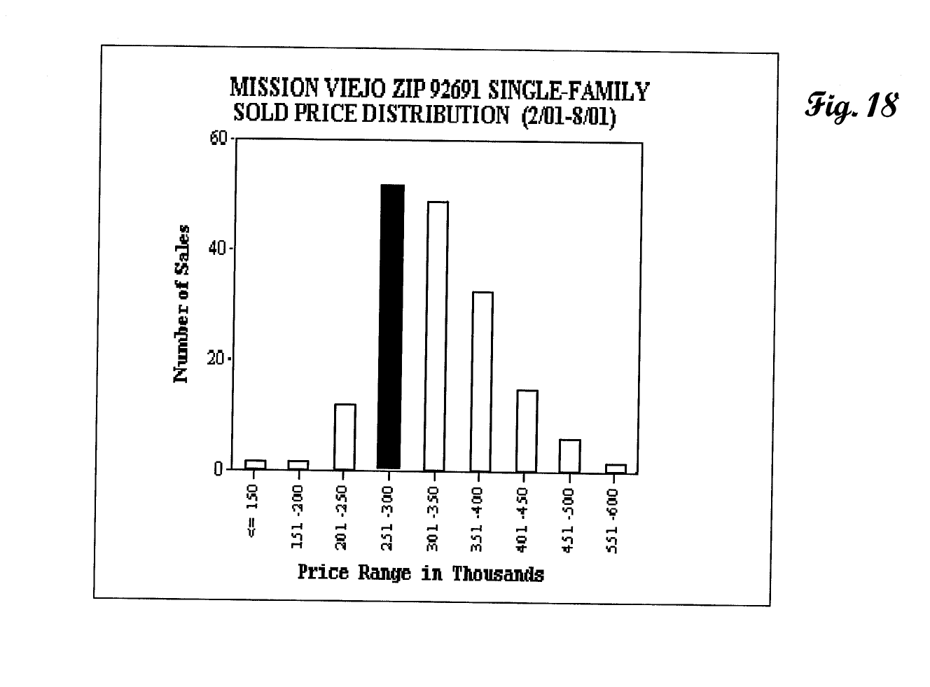

FIG. 18 shows a sales price distribution chart generated by the comparable market analysis engine in the VYH server software. This chart shows the distribution of sales by price range in the vicinity of a subject property selected by a user using VYH query pages. The “black” shaded bar denotes in which price range the estimated value of the subject property lies. All things equal, a seller would want to see this bar situated in the highest activity price ranges.

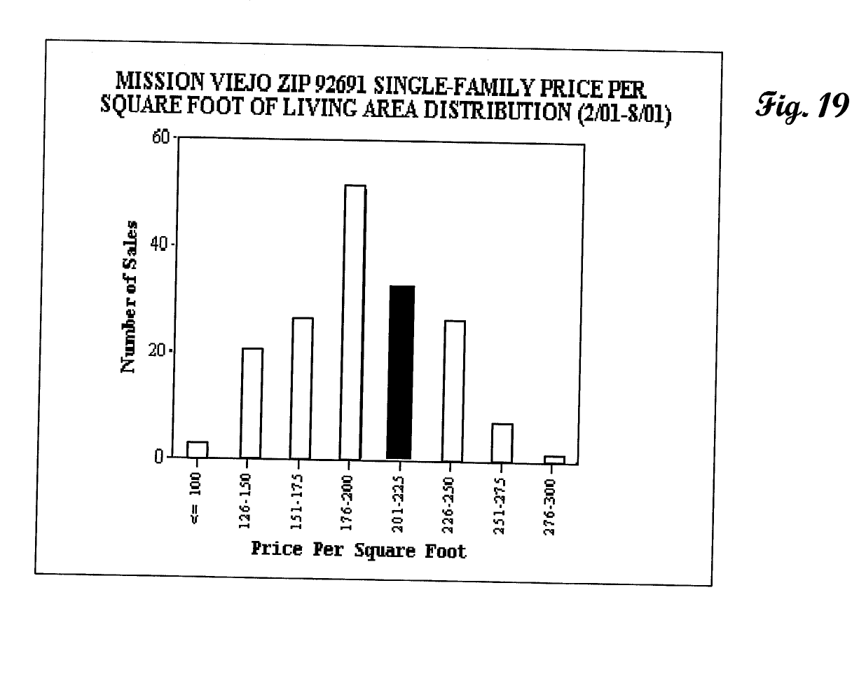

FIG. 19 shows a “per square foot” sales price distribution chart generated by the comparable market analysis engine in the VYH server software. This chart shows the distribution of sales price, expressed on a per square foot of living area basis (i.e. sold price divided by living area in square feet), in the vicinity of a subject property selected by a user using VYH query pages. The “black” shaded bar denotes in which price per square foot range the estimated value of the subject property lies. All things equal, a seller would want to see this bar situated in the highest activity price per square foot ranges. The comparable market analysis engine can also generated a “price per bedroom” sales distribution chart, where “price per bedroom” is the closed sale price of a dwelling divided by the number of bedrooms in the dwelling.

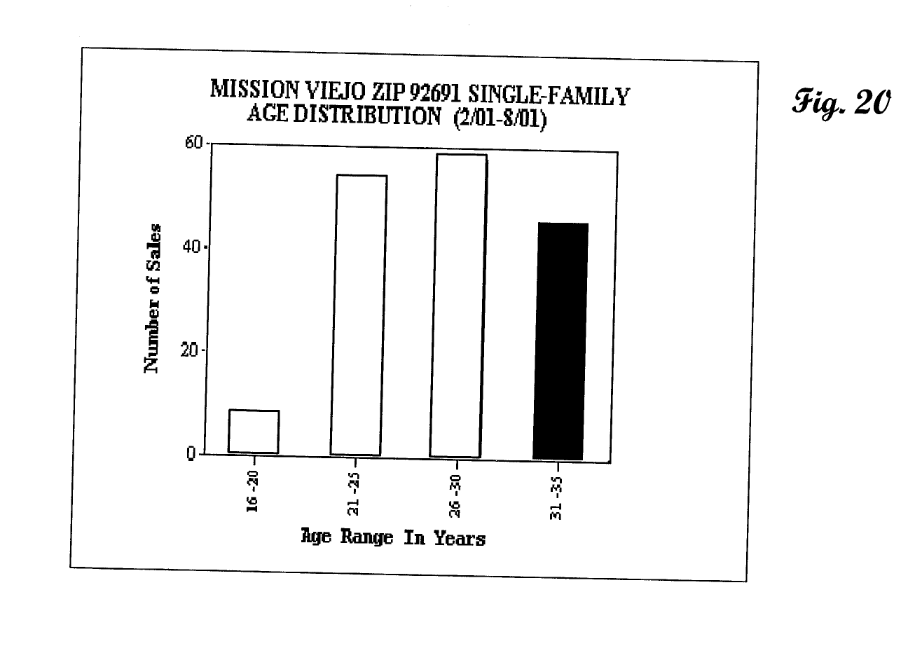

FIG. 20 shows an “age of property” sales price distribution chart generated by the comparable market analysis engine in the VYH server software. This chart shows the distribution of sales by age of home in the vicinity a subject property selected by a user using VYH query pages. The “black” shaded bar denotes in which age range the subject property lies.

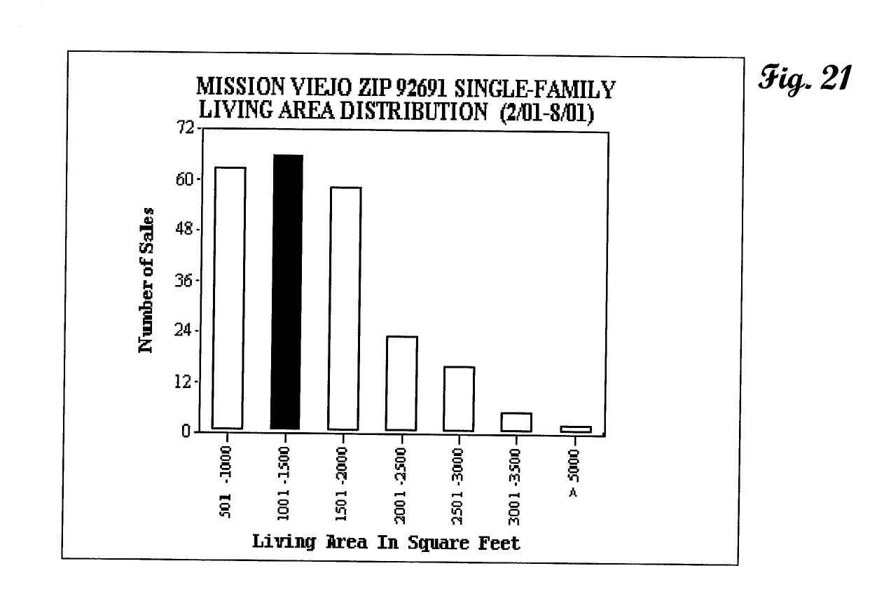

FIG. 21 shows an “sales by living area” distribution chart generated by the comparable market analysis engine in the VYH server software. This chart shows the distribution of sales by living area in the vicinity of a subject property selected by a user using VYH query pages. The “black” shaded bar denotes in which living area range the subject property lies. All things equal, a seller would want to see this bar situated in the highest activity living area ranges.

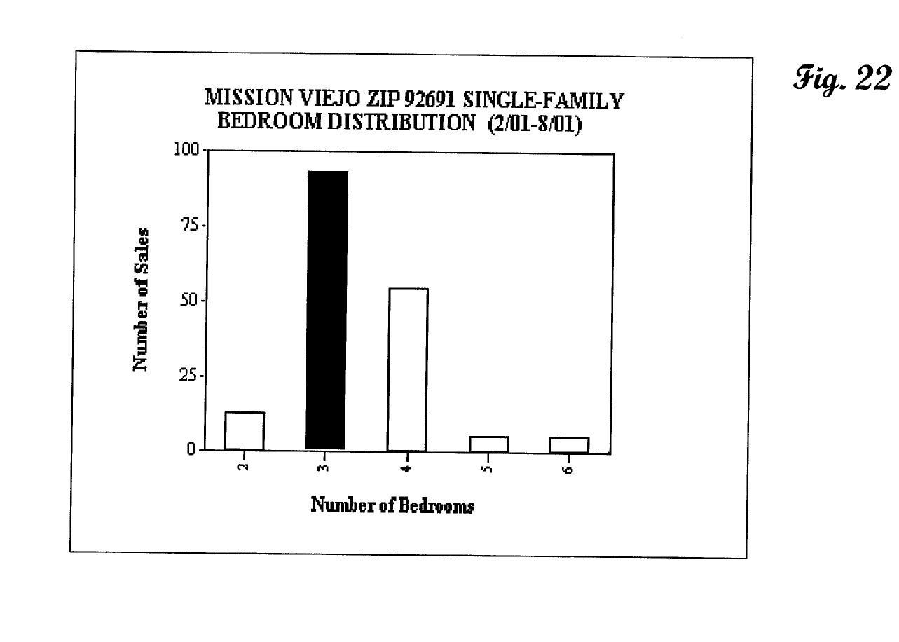

FIG. 22 shows an “sales by bedroom” distribution chart generated by the comparable market analysis engine in the VYH server software. This chart shows the distribution of sales by bedroom count in the vicinity of a subject property selected by a user using VYH query pages. The “black” shaded bar denotes the number of bedrooms of the subject property and where that bedroom count lies in the overall distribution. All things equal, a seller would want to see this bar situated in the highest activity bedroom levels.

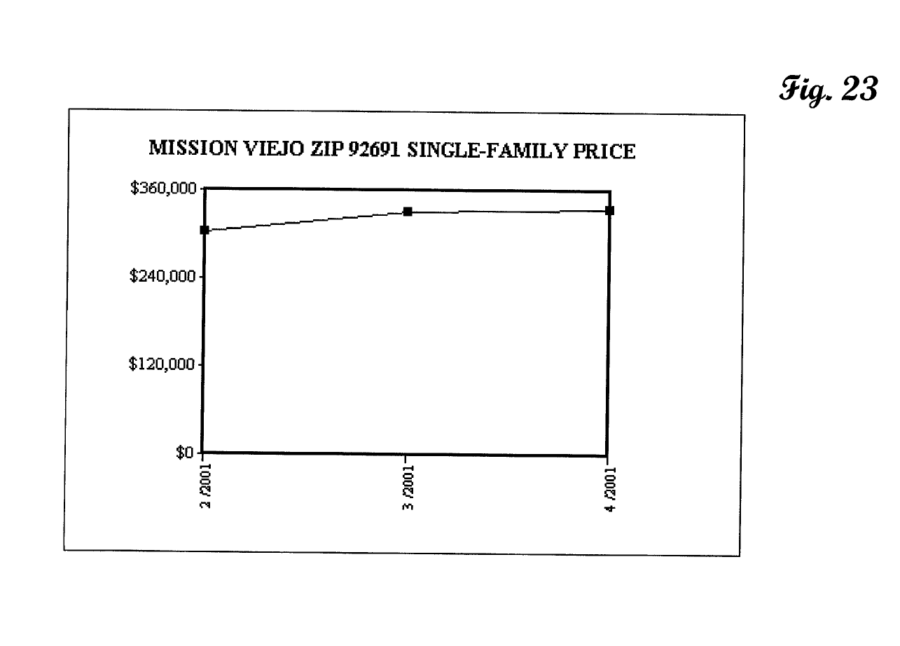

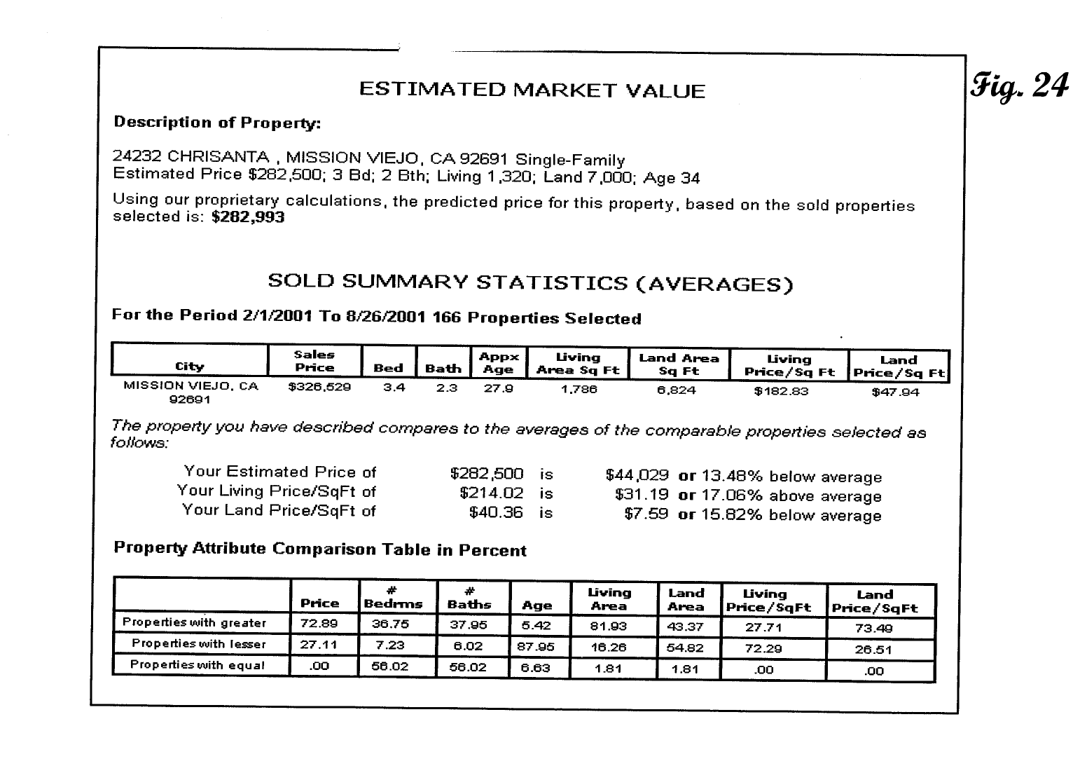

FIG. 23 illustrates a simple trend line of average sales prices for single family homes for use in comparison with the far more informative decision tools illustrated in FIGS. 17 through 22. FIG. 24 shows a predicted sales price, or appraisal, generated by the comparable market analysis engine together with statistical information that analyze a subject property selected by a user with the properties selected by the user as input into the comparable market analysis engine.

As discussed above, by storing metadata in the VYH database, query parameters can be conditioned and presented, or not, to the user for selection. The conditioning capabilities are important, since there is no uniform set of property data types at a national or state or even city level, and many MLSs and state property tax databases do not contain all of the VYH data types. Through the metadata and data preconditioning process in the VYH invention, the following query parameters and VYH data types are conditioned based on metadata when Sales Trend and Comparable Market Analysis decision tools are generated:

Present or suppress the ability to input a value range for dwelling (Living Area) square feet;

Present or suppress the ability to input a value range for Year Built;

Present or suppress the ability to input a value range for Lot Size (Land Area) (in square feet, or, in fall or partial acres);

Condition the values that populate the value range for the (Number of) Years To Graph (i.e., metadata is used to track the earliest date of a property sale, within each unique geographic region stored in the database);

Condition the list of available values in the Property Type selection list;

Condition the list of available values in the Pool selection list; and

Condition the list of available graphs and decision tools that may be selected for provision to the user.

To generate buy/sell signals, a user completes and submits query pages similar to the ones generated by the trend engine and selects properties from a list showing properties that have recently sold and that are within a user-selectable radius or rectilinear distance from the subject property. Optionally, other proximity parameters can be used to restrict the property data submitted to the buy/sell signals engine. The VYH invention adapts a technique used in securities trading, called “moving average-convergence/divergence”, or “MACD”, for use in real estate sales.

Real estate prices have historically moved in long waves with peaks occurring approximately every 10 years. Along the way, the current trends tend to be quite persistent, i.e., when prices are flat, prices tend to remain flat, while when prices are rising, prices tend to continue to rise. In the case of the single family market, one of the reasons for this behavior is the nature of the home purchase. The acquisition of a home by an owner occupant essentially involves two types of decisions, which are jointly related. First is the purchase of housing services (a place to live), while second is the purchase of an asset (an investment). This is the primary reason why housing prices are typically what is called “sticky”, or resistant, on the downside. When prices are rising, the investment component of the purchase becomes a very important consideration, while when prices are stable, the homeowner is still getting housing services. This is in contrast to more traditional investments such as equities where there would be little incentive to hold a position if one knew that prices were going to remain flat (or go down).

The fact that home prices tend to be relatively smooth and move in longer period waves makes them very amenable to some well known “trend-following” indicators used in the analysis of the financial markets. In this regard, the VYH buy/sell signals engine uses moving average trend lines generated by the trend engine to generate another decision tool, buy/sell signals, which have proven to be quite accurate in identifying optimal points to enter and exit individual real estate markets.

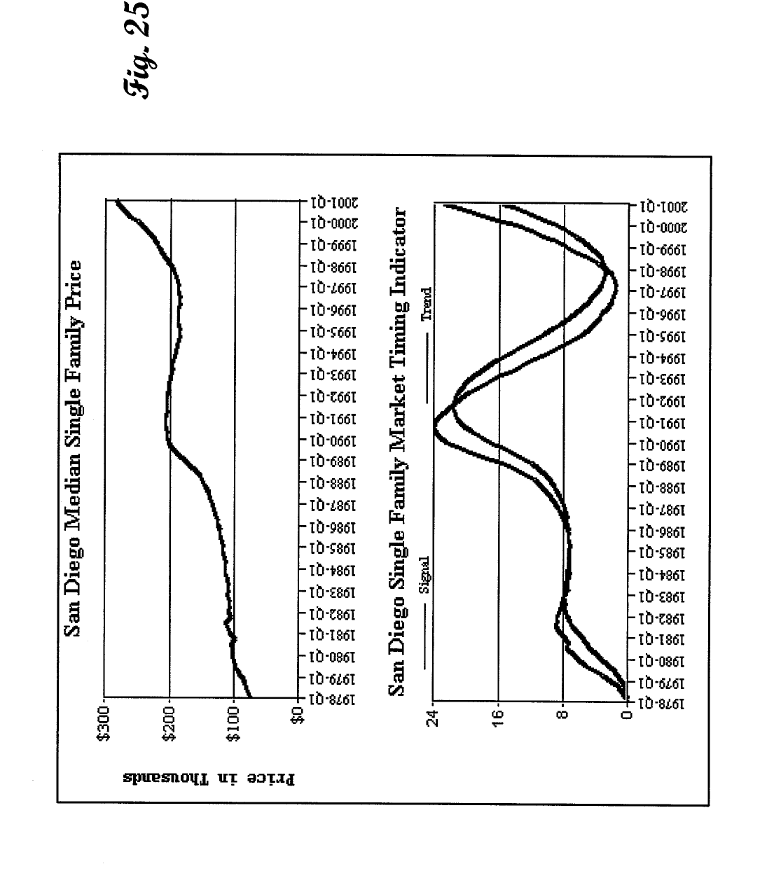

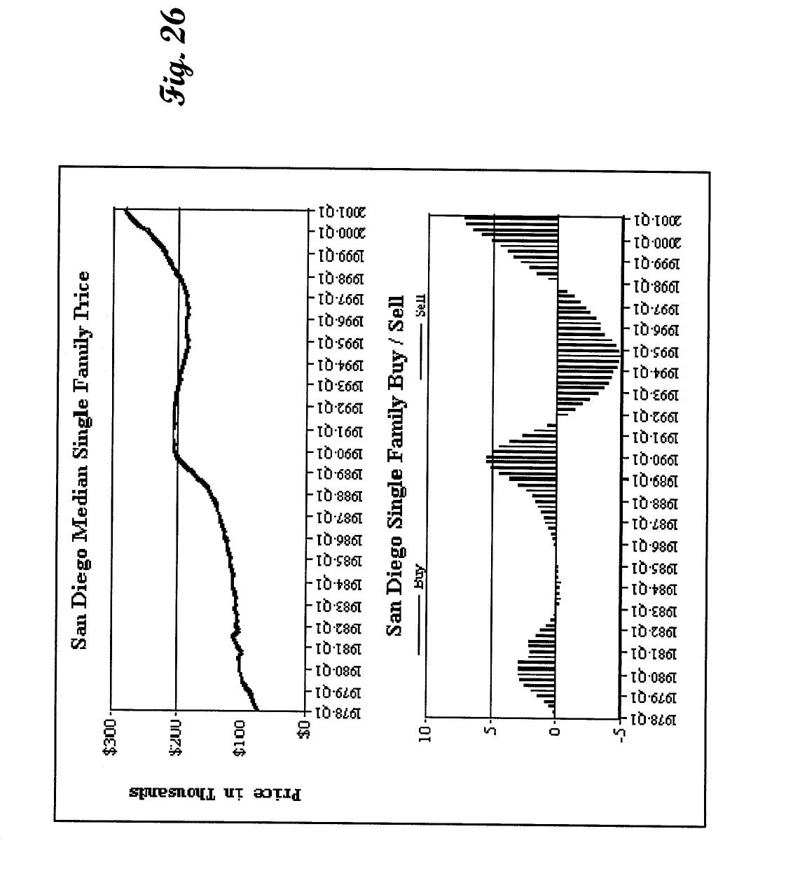

FIGS. 25 and 26 show trend lines, and buy/sell signals derived from those trend lines, back to 1978 for the overall San Diego single family home price, as generated by the buy/sell signals engine of the VYH server software. FIG. 25 shows the median sales price of single family homes in San Diego and a MACD market timing indicator for those homes single family homes. FIG. 26 shows the median sales price of the same single family homes in San Diego as in FIG. 25 and buy/sell signals derived from the MACD market timing indicator in FIG. 25. The market timing indicator consists of two lines—the trend and signal lines. A buy/sell signal is calculated by taking the difference between the trend and signal lines. The buy/sell signals engine in the invention can compute and provide decision tools (primarily graphs) that depict several types of MACDs, including a MACD in which a 12 month moving average is plotted against a 26 month moving average. The most straightforward use of a buy/sell signal is to enter the market when the buy/sell signal crosses above the zero line (the x-axis in FIG. 26) and exit the market when the Buy/Sell Indicator crosses below the zero line. As shown, there was a buy signal in 1978 followed by a sell signal in 1983. This corresponded to a price move from $60,600 to $102,700 or 69.5 percent. The next buy signal occurred in 1986 when the price was at $117,100. This signal remained in effect until 1991 at a price of $208,700, corresponding to a gain of 78.2 percent. Of note, is that by exiting the market at that time, one would have avoided a price decline of $22,900 or 11.0 percent by the second quarter of 1998. More important, this signal would have kept a buyer out of the market, which ultimately declined for more than six years. The next buy signal occurred in 1998 at a price of $185,800 and is still in effect.

The VYH appraisal engine generates an appraisal (i.e., a sales price prediction or valuation) using output from the trend engine, output from the comparable market analysis engine, or a combination of outputs from those engines. To generate an appraisal, a user completes and submits query pages similar to the ones generated by the trend engine, and selects a geographic area within a user-selectable radius or rectilinear distance from the subject property. Optionally, additional proximity parameters can be used to restrict the property data submitted to the appraisal engine. The appraisal engine incorporates the information provided by the user in the sales price prediction algorithms to calculate an appraisal tailored to the subject property or to a specific market segment. For instance, increasing the weighting of “proximity to grade schools” would boost sales prices for properties targeting buyers with grade school age children. Proximity to recreational, professional, and other facilities affects weightings (coefficients) in the regression analysis and similar modeling techniques used to calculate a predicted sales price.

Sales price prediction for real estate properties has traditionally been done by comparable market analysis, primarily because decision tools based on trend analysis of transactions in real property, and the property data required to perform such trend analysis, were uncommon. Trend analysis is used in several ways to predict a sales price for a subject property. Trend analysis not only offers an alternative to comparable market analysis, but also enables the generation of buy/sell signals, which have heretofore been rare or unknown in the real estate industry.

There are a number of techniques used in computerized valuation, also known as automatic valuation models (AVMs), for estimating property values, which is the same as predicting sales prices when done prospectively. Most AVM techniques use some form of multiple regression analysis, which a statistical method to quantify the value of a home by determining quantitative factors for its attributes. The attributes typically include the living and lot areas of the home, its age, the number of bedrooms, etc. The analysis is based upon a sample of comparable sales in the general vicinity of the subject property. Once the factors for the general neighborhood are determined, they are entered into an equation which can be used to estimate the market value of the subject property based upon the values of its particular attributes.

One of the techniques used by the more sophisticated AVMs, such as those used by economic researchers, is to adjust forward in time a previous sale price of a home to determine a current market value. This is typically done by using overall market price trend factors such as those reported by Office of Federal Housing Enterprise Oversight (“OFHEO”). A typical calculation would be as follows: if a home located in Los Angeles County sold for $200,000 in 1995 and the overall Los Angeles market increased by 20 percent between then and now, then a current estimate for the value of the home would be $240,000. While this is a good technique, a significant weakness is that it uses a broad price index for an overall city or Statistical Marketing Area (“SMA”) (e.g. Los Angeles, San Diego). Such an index will undoubtedly be too general to accurately reflect the trends of home prices in more specific areas or neighborhoods.

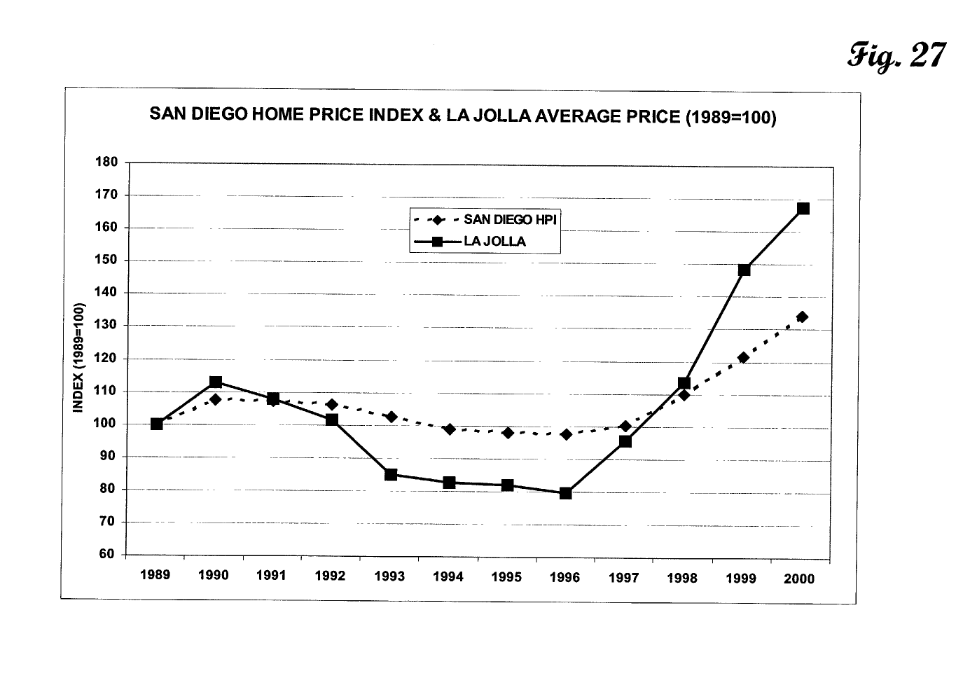

FIG. 27 shows the overall San Diego OFHEO price index and an index of home prices for the La Jolla market in the same time period, as generated by the VYH trend engine. La Jolla is a suburb of San Diego. Notice the significant differences between the two trend lines, which would lead to very misleading valuations for a La Jolla property if only the overall San Diego index for price/time adjustments were used. The VYH invention provides much more specific historical price trends to time-adjust individual home prices. This can be done on a city, zip code, or geographic radius or rectilinear distance around a subject property basis. Moreover, home price adjustment indexes can be developed for more specific factors (e.g., use property data only for three bedroom homes, or only for homes between 1500 and 2500 square feet of living area, as inputs to the trend engine) or for different property types (e.g., condominiums, duplexes). Thus, the VYH invention enables significant improvements in decision tools based on trend analysis.

To generate a predicted sales price, the VYH trend engine takes the most recent average price, price per bedroom, and price per square foot on the trend line generated for similar properties within a radius or rectilinear distance of a subject property, and applies these metrics to the subject property. Trend analysis methods are a significant improvement over comparable market analysis methods, since time adjustment factors can be used and very specific trends can be calculated. In particular, the trend engine calculates time adjustment factors down to a per bedroom or per living area values and in specific neighborhoods. Experience using the VYH invention has shown that the trends and time adjustments can be quite different even within the same neighborhood (e.g. 4 bedroom homes may have appreciated at a higher rate than 3 bedroom homes). After a year of use of the trend engine to predict sales prices, the trend engine has proven to be significantly more accurate than comparable market analysis, and with existing AVMs, when predicted and closed sales prices are compared.

The trend engine also uses a second multiple regression technique, called a hedonic model, to predict sales prices based upon the attributes of a subject property, e.g., number of bedrooms, baths, living area, age, etc. This hedonic model uses a “least absolute deviation” (LAD) multiple regression technique. This is contrary to the prevalent use of “least square” deviation in multiple regression analysis. LAD regression is better adapted for use with real estate sales data because LAD is less affected by the common problem of outliers.

In an alternative embodiment, the appraisal engine can bring to a seller's attention how the sales price might be increased by identifying target markets responsive to certain features detected by the GIS software in the invention. For instance, the GIS software presents a prospective seller with suggestions about proximity to educational institutions, mass transit, freeways, parks, recreational facilities, architectural features (e.g., home LAN, accessibility, security), etc. The architectural, home furnishing, and landscaping engine of the invention can detect architectural, home furnishing, and landscaping features that the subject property lacks as compared with comparable properties, and suggests to prospective sellers how architectural and landscaping improvements might increase the predicted sales price. The invention can present to users offers or referrals of vendors who can provide goods or services to the users.

In a further alternative embodiment, the appraisal engine also can be used for the benefit of prospective buyers, with the objective of identifying acceptable properties with lower predicted sales prices. A prospective buyer can direct the tailored appraisal engine to identify properties in which values for specified proximity, architectural, home furnishing, landscaping, and similar features are low, if such features are less important for such buyer, or if the buyer has alternative means of compensating for such features. As an example, a buyer without children may wish to be remote from K-12 schools, and could assign proximity to K-12 schools a lower weight than the average buyer. The properties identified by the appraisal engine in “buyer mode” can be rank ordered by appraisal score or by predicted sales price.

The VYH invention can be operated in several configurations: (i) standalone online (i.e., private network) or Web portal, e.g., a Website primarily concerned with real property valuation; or (ii) as a supplemental service for other portals, e.g., Websites primarily concerned with real estate mortgage lending, mortgage insurance, real property insurance, home furnishings, home improvements, etc. The data sources, data mapping, data validation, data filtering, displays, interactive dialog, algorithms, comparable market analysis, and other components of a given installation of the VYH invention can be tailored to serve residential real estate, commercial real estate, industrial real estate, or all three types of real estate. The invention can also be configured for use for sales of properties, for rentals of properties, or for both sales and rentals of properties.

We claim:

1. A system of improving the accuracy of analytic processing of real estate data, the improvement comprising,
a means for data mapping, and
a means for preconditioning data.

2. A system of improving the accuracy of analytic processing of real estate data, the improvement comprising,
a means for data mapping,
a means for filtering data, and
a means for preconditioning data.

3. A system for providing real estate information, comprising,
at least one server computer hosting server software,
at least one user computer hosting a user interface and interfaced with the server computer via a data communications path, and
a database of real estate property data hosted on the server computer, which database is populated with data that has been data mapped and preconditioned.

4. The system of claim 3, further comprising,
at least one analytic engine hosted on the server computer and selected from the group comprising trend engine, comparable market analysis engine, buy/sell signals engine, and appraisal engine.

5. The system of claim 3, further comprising,
a trend engine hosted on the server computer and at least one similarly hosted analytic engine selected from the group comprising a comparable market analysis engine, buy/sell signals engine, and an appraisal engine.

6. The system of claim 3, further comprising,
a comparable market analysis engine hosted on the server computer and at least one similarly hosted analytic engine selected from the group comprising trend engine, buy/sell signals engine, and appraisal engine.

7. The system of claim 3, further comprising,
a buy/sell signals engine hosted on the server computer and at least one similarly hosted analytic engine selected from the group comprising trend engine, comparable market analysis engine, and appraisal engine.

8. The system of claim 3, further comprising,
an appraisal engine hosted on the server computer and at least one similarly hosted analytic engine selected from the group comprising trend analysis, comparable market analysis, and buy/sell signals analysis.

9. A system for providing residential real estate information, comprising,
at least one server computer hosting server software,
at least one user computer hosting a user interface and interfaced with the server computer via a data communications path, and
a database of residential real estate property data hosted on the server computer, which database is populated with data that has been data mapped and preconditioned.

10. The system of claim 9, further comprising,
at least one analytic engine hosted on the server computer and selected from the group comprising trend engine, comparable market analysis engine, buy/sell signals engine, and appraisal engine.

11. The system of claim 9, further comprising,
a trend engine hosted on the server computer and at least one similarly hosted analytic engine selected from the group comprising a comparable market analysis engine, buy/sell signals engine, and an appraisal engine.

12. The system of claim 9, further comprising,
a comparable market analysis engine hosted on the server computer and at least one similarly hosted analytic engine selected from the group comprising trend engine, buy/sell signals engine, and appraisal engine.

13. The system of claim 9, further comprising,
a buy/sell signals engine hosted on the server computer and at least one similarly hosted analytic engine selected from the group comprising trend engine, comparable market analysis engine, and appraisal engine.

14. The system of claim 9, further comprising,
an appraisal engine hosted on the server computer and at least one similarly hosted analytic engine selected from the group comprising trend analysis, comparable market analysis, and buy/sell signals analysis.

15. A system for providing real estate information, comprising,
at least one server computer hosting server software,
at least one user computer hosting a user interface and interfaced with the server computer via a data communications path, and
a database of real estate property data hosted on the server computer, which database provides the following graphical historical price charts decision tools in response to queries submitted by a user operating a user computer, generated by a query of data in a given range around a subject property and in a geographic level specified by the user, and selected from the group comprising: charting home sold price and monthly sales volume over time; charting home sold price per square foot of living area over time; charting home sold price per square foot of lot area over time; charting home sold price per bedroom over time; charting average or median age of homes sold over time; and charting average or median size of homes sold over time.

16. A system for providing real estate information, comprising,
at least one server computer hosting VYH server software,
at least one user computer hosting a user interface and interfaced with the server computer via a data communications path, and
a database of real estate property data hosted on the server computer, which database provides the following graphical geographical information system market maps decision tools in response to queries submitted by a user operating a user computer, generated by a query of data in a given range around a subject property and in a geographic level specified by the user, and selected from the group comprising: charting average or median home prices for different states on a map color coded by price; charting average or median home prices for different counties on a map color coded by price; charting average or median home prices for different zip codes on a map color coded by price; charting average or median home prices for different cities or municipalities on a map color coded by price; and charting per zip code on individual maps, color coded by range, reflecting—average single family sold price, number of single family sales, total single family sales volume, average single family price appreciation rate between specified dates, average single family sold price per square foot of living area, average single family sold price per bedroom, average age of single family homes sold, and any one of the preceding decision tools as a time sequence.

17. A system for providing real estate information, comprising,
at least one server computer hosting server software,
at least one user computer hosting a user interface and interfaced with the server computer via a data communications path, and
a database of real estate property data hosted on the server computer, which database provides the following graphical price distribution charts decision tools in response to queries submitted by a user operating a user computer, generated by a query of data in a given range around a subject property and in a geographic level specified by the user, and selected from the group comprising: charting average or median home sold price distribution; charting average or median home sold price per square foot distribution; and showing any one of the preceding distribution charts as a time sequence.

18. A system for providing real estate information, comprising,
at least one server computer hosting server software,
at least one user computer hosting a user interface and interfaced with the server computer via a data communications path, and
a database of real estate property data hosted on the server computer, which database provides the following graphical historical mortgage charts decision tools in response to queries submitted by a user operating a user computer, generated by a query of data in a given range around a subject property and in a geographic level specified by the user, and selected from the group comprising: general mortgage statistics; charting average or median home price and mortgage amount over time; charting average or median mortgage loan-to-value ratio over time; charting average or median mortgage by type over time; charting average or median mortgage volume by top lenders over time single lender mortgage statistics; charting individual mortgage lender monthly average or median home price and mortgage amount over time; charting individual mortgage lender average or median loan-to-value ratio over time; charting individual mortgage lender monthly average or median mortgage by type over time; and charting individual mortgage lender loan volume over time.

19. A system for providing real estate information, comprising,
at least one server computer hosting server software,
at least one user computer hosting a user interface and interfaced with the server computer via a data communications path, and
a database of real estate property data hosted on the server computer, which database provides the following graphical technical analysis of historical home price series decision tools in response to queries submitted by a user operating a user computer, generated by a query of data in a given range around a subject property and in a geographic level specified by the user, and selected form the group comprising: charting the price and a best fit trend line; charting the price and a “smoothness priors” line; charting the price and various moving averages; charting the price and the relative strength index; charting the price and the moving average-convergence/divergence index; charting the price and on balance volume; charting the price and money flow index; charting the price and percent change on a periodic basis; charting the price and volatility bands; providing time series forecasts of monthly prices; and charting any one of the preceding decision tools as a histogram.

20. A system for providing real estate information, comprising,
at least one server computer hosting server software,
at least one user computer hosting a user interface and interfaced with the server computer via a data communications path, and
a database of real estate property data hosted on the server computer, which database provides the following graphical fundamental analysis of historical home price series decision tools in response to queries submitted by a user operating a user computer, generated by a query of data in a given range around a subject property and in a geographic level specified by the user, and selected from the group comprising: charting the employment growth; charting the unemployment rate; charting the new construction as measured by the number of building permits issued; charting the trends in median rents; charting the rental vacancy rate; ranking and charting price performance over periods in a histogram; ranking and charting fundamental performance over periods by population, employment, total personal income, and building permits; ranking by price performance and fundamental performance; and graphically correlating monthly price and fundamental factors.
